(19) United States
(12) Patent Application Publication
(10) Pub. No.: US 2009/0104984 A1
(43) Pub. Date: Apr. 23, 2009

(54) GAMING SYSTEM IN WHICH A PLURALITY OF SLOT MACHINES SCRAMBLE FOR AWARDS

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE Corp., Tokyo (JP)

(21) Appl. No.: 12/256,288

(22) Filed: Oct. 22, 2008

(30) Foreign Application Priority Data
Oct. 22, 2007 (JP) 2007-273407

(51) Int. Cl. A63F 9/24; A63F 13/00

(52) U.S. Cl. 463/27

(57) ABSTRACT

When a player presses an entry button, each slot machine can take part in a boxing game that is managed by a game server. Once the boxing game starts, each slot machine calculates the point amount on the basis of the number of each of symbols [ATTACK] and [DAMAGE] that are displayed on display windows until a unit game of a slot game is repeated the predetermined number of times after the entry button is pressed. Meanwhile, the game server compares the calculated point amounts and determines win/lose of the boxing game. In each of the slot machines that are determined as losers, the entire credit amount that is owned by a player is confiscated, and almost the entire confiscated credit amount is given to the slot machine that is determined as a winner.

### CROSS-REFERENCE TO RELATED APPLICATIONS

This application claims priority from the prior Japanese Patent Application No. 2007-273407 filed on Oct. 22, 2007, the disclosure of which is herein incorporated by reference in its entirety.

### BACKGROUND

1. Field

The present invention relates to a gaming system in which a plurality of slot machines scramble for awards.

2. Description of Related Art

As an example of a gaming system that has been conventionally used, there is a gaming system in which a plurality of slot machines share one progressive jackpot. In this gaming system, a portion of a bet of a unit game is accumulated in a jackpot fund whenever a unit game is conducted in each slot machine. If a specific winning combination is realized at a unit game of an arbitrary slot machine, the jackpot fund is awarded to the applicable slot machine. After that, the jackpot fund is reset. Accordingly, in the gaming system, the plurality of slot machines scramble for the jackpot fund.

As prior-art document information that is related to a gaming system in which a plurality of slot machines scramble for awards, there is U.S. Pat. No. 6,142,872.

However, even though a portion of a player's own bet is accumulated in the jackpot fund, only a portion of the bet that corresponds to less than one percent or several percents of the bet at the most is shifted in the jackpot fund. For this reason, even though the jackpot fund is awarded, a player feels neither the player has taken other players' bets nor the player's own bet has been taken.

In each slot machine, the jackpot fund is awarded when a specific winning combination is realized. Accordingly, there is a tendency that a player of each slot machine does not think a slot game as a game where the plurality of slot machines scramble for a jackpot fund but thinks the slot game as a game that is individually conducted by the plurality of slot machines, with respect to the progressive jackpot.

### SUMMARY

Accordingly, the invention has been made to solve the above-described problems, and it is an object of the invention to provide a gaming system that can clearly show, to each player, a game where a player's own awards are bet between slot machines.

To achieve the object of the disclosure, there is provided a gaming system comprising: game clients that are composed of a plurality of slot machines, respectively; and a game server that manages the individual game clients, wherein the each game client is programmed to execute the following processes (a) to (c) of: (a) simultaneously executing a slot game and a grab game on which the total credit amount that is awarded at the slot game is bet; (b) transmitting game-related information related to the grab game to the game server; and (c) calculating the total credit amount on the basis of game-win/lose information when the following game-win/lose information has been received from the game server, and the game server is programmed to execute the following processes (α) to (γ) of: (α) determining a winner and losers of the grab game for each of the game clients on the basis of the game-related information when the game-related information has been received; (β) transmitting, to the game clients determined as the losers of the grab game by the process (α), game-win/lose information indicating that the total credit amount of the game clients is to be confiscated; and (γ) transmitting, to the game client determined as the winner of the grab game by the process (α), game-win/lose information indicating that the distributable credit amount among the total credit amount of the game clients determined as the losers of the grab game by the process (α) is to be given.

Furthermore, according to another aspect, there is provided a gaming system comprising: game clients that are composed of a plurality of slot machines, respectively; and a game server that manages the individual game clients, wherein the each game client includes an input device and a display and is programmed to execute the following processes (a) to (f) of: (a) transmitting entry information, which indicates that the game clients take part in a grab game on which the total credit amount that is awarded at the slot game is bet, to the game server when players use the input devices to input data indicating that the game clients take part in the grab game; (b) executing the grab game on the displays in asynchronous with a unit game of the slot game on the basis of game-start information or game content information when the following game-start information or the following game content information has been received from the game server; (c) transmitting game operation information related to operation data of the grab game to the game server when the players use the input devices to input the operation data of the grab game while the grab game is executed on the displays; (d) displaying an approval screen requesting an acceptance of disengagement from the grab game on the display when a first predetermined time has elapsed after the unit game of the slot game is executed but a next unit game is not executed yet; (e) transmitting disengagement information, which indicates that the game clients are disengaged from the grab game, to the game server when a second predetermined time has elapsed after the approval screen is displayed on the display but the next unit game is not executed yet; and (f) calculating the total credit amount on the basis of game-win/lose information when the following game-win/lose information has been received from the game server, and the game server is programmed to execute the following processes (α) to (δ) of: (α) when the entry information has been received, determining the game clients that have transmitted the entry information as participants of the grab game; (β) when a number of game clients determined as the participants has reached a predetermined number, transmitting game-start information indicating that the grab game starts to the game clients determined as the participants by the process (α); (γ) when the disengagement information has been received, changing the game client as the participant of the grab game that has transmitted the disengagement information to the game server that has a predetermined credit amount; (δ) when the game operation information has been received, determining a situation of the grab game or a winner and losers of the grab game for each game client that has transmitted the game-start information in the process (β) on the basis of the game operation information; (ε) when the situation of the grab game is determined in the process (δ), transmitting game content information related to the situation of the grab game determined in the process (δ) to the game clients that have transmitted the game-start information in the process (β); and (ζ) when the winner and losers of the grab game is determined in the process (δ), transmitting game-win/lose information indicating that the total credit amount of the game clients is to be confiscated to the game clients determined as the losers of the grab game by the process (δ), while transmitting game-win/lose information indicating that the distributable credit amount among the total credit amount of the game clients determined as the losers of the grab game is to be given to the game client determined as the winner of the grab game by the process (δ).

### BRIEF DESCRIPTION OF THE DRAWINGS

FIG. 1 is a view showing characteristics of a gaming system according to one embodiment of the present invention;

FIG. 2 is a system block diagram showing the gaming system;

FIG. 3 is an external perspective view of each slot machine;

FIG. 4 is a schematic view showing symbol columns drawn on each mechanical reel;

FIG. 5 is a block diagram schematically showing an internal construction of entire slot machine;

FIG. 6 is a block diagram schematically showing an internal construction of a sub control board;

FIG. 7 is a payout table showing winning combinations and payout amounts thereof when a slot game is executed by using each mechanical reel;

FIG. 8 is a view showing an image example displayed on the liquid crystal panel;

FIG. 9 is a view showing an image example displayed on the liquid crystal panel;

FIG. 10 is a schematic view showing symbol columns drawn on each video reel;

FIG. 11 is a table showing correspondence relationships between a symbol and a point;

FIG. 12 is a view showing an image example displayed on the liquid crystal panel;

FIG. 13 is a view showing an image example displayed on the liquid crystal panel;

FIG. 14 is a view showing an image example displayed on the liquid crystal panel;

FIG. 15 is a view showing an image example displayed on the liquid crystal panel;

FIG. 16 is a flowchart of a main control program;

FIG. 17 is a flowchart of a main game process program;

FIG. 18 is a flowchart of the control program executed in between each gaming machine and a game server;

FIG. 19 is a flowchart of a main game process program;

FIG. 20 is a flowchart of a control program executed in between each gaming machine and the game server;

FIG. 21 is a view showing an image example displayed on the liquid crystal panel;

FIG. 22 is a flowchart of a main game process program;

FIG. 23 is a flowchart of a control program executed in between each gaming machine and the game server;

FIG. 24 is a view showing an image example displayed on the liquid crystal panel; and

FIG. 25 is a flowchart of a main control program.

### DETAILED DESCRIPTION

[1. Outline of the Invention]

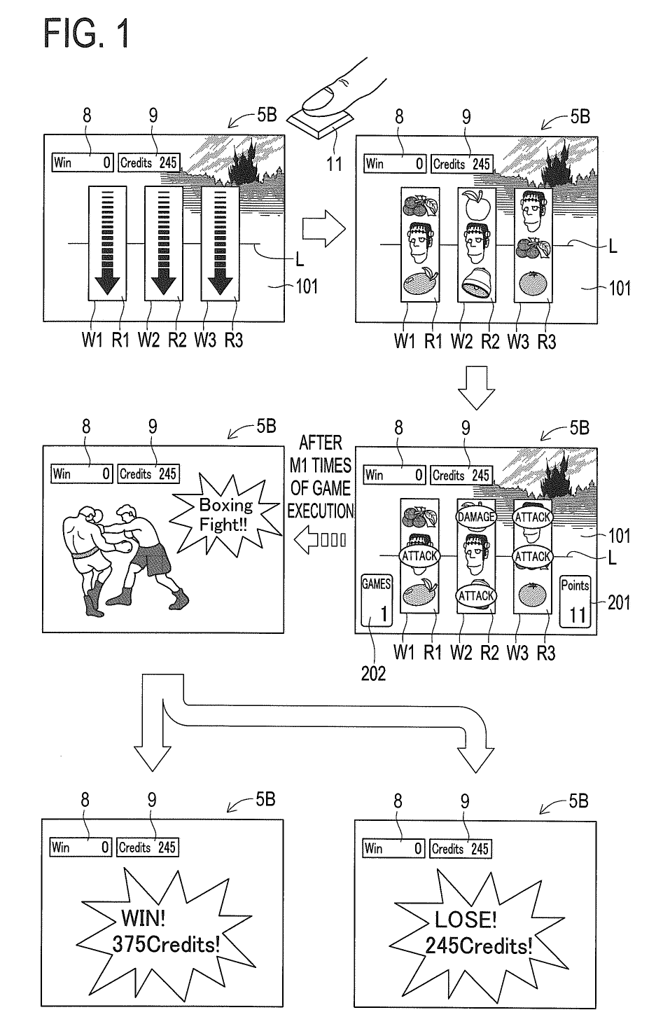

Hereinafter, embodiments of the invention will be described with reference to the accompanying drawings. In a gaming system according to this embodiment, a plurality of slot machines are connected to a game server through a network that enables bidirectional communication. FIG. 1 is a view showing the characteristics of a gaming system according to an embodiment of the invention, which specifically shows a liquid crystal panel 5B that is provided to one slot machine connected to a game server.

In this regard, the liquid crystal panel 5B where a slot game is developed is composed of a known transparent liquid crystal panel. As shown at both sides of the upper stage of FIG. 1, symbols of three mechanical reels R1, R2, and R3 are arranged three by three through three display windows W1, W2, and W3 that are in a transparent state. One pay line L, which horizontally crosses the display windows W1, W2, and W3, is displayed on the liquid crystal panel 5B. The pay line L is used to specify a combination of symbols. Further, a touch panel 101 is provided in a front surface of the liquid crystal panel 5B. As shown at both sides of the upper stage of FIG. 1, a payout amount display portion 8 and a credit amount display portion 9 are provided in the liquid crystal panel 5B.

In the slot game, on the other hand, various winning combinations are determined beforehand on the basis of each combination of symbols. As shown in the liquid crystal panel 5B at both sides of the upper stage of FIG. 1, when the mechanical reels R1, R2, and R3 rotate or stop, three symbols are rearranged on each of the display windows W1, W2, and W3. At this time, when a symbol combination that is composed of three symbols rearranged on the pay line L corresponds to any one of winning combinations, an amount that is obtained by multiplying a payout amount according to the corresponding winning combination with the bet amount is displayed on the payout amount display portion 8. As a result, a unit game of a slot game is constituted. The payout amount that is displayed on the payout amount display portion 8 is added and displayed on the credit amount display portion 9, when the corresponding unit game is finished.

However, in the gaming system according to this embodiment, when a player of the slot machine presses an entry button that is one of the operation buttons 11, the game server specifies another slot machine where a player presses an entry button as one of the operation buttons 11 in the same method, among other slot machines that are connected to the game server. Under a condition where the specified slot machine and the corresponding slot machine are matched with each other by the game server, a boxing game that is an example of a grab game is executed in parallel with the slot game in a method described below from a point of time when the subsequent unit game is finished.

In other words, as shown in the liquid crystal panel 5B at the right side of the middle stage of FIG. 1, when the unit game is finished, video reels where reel bands are made transparent except for the symbols drawn on the reel bands are rotated and stopped, and thus a symbol [ATTACK] or [DAMAGE] is displayed on each of the display windows W1, W2, and W3. At this time, a point of [+3] is given to one symbol [ATTACK] and a point of [−1] is given to one symbol [DAMAGE].

Further, as shown at the right side of the middle stage of FIG. 1, a point display portion 201 is provided in the liquid crystal panel 5B. In addition, the point amount is calculated according to the number of each of displayed symbols [ATTACK] and [DAMAGE], and the calculated point amount is displayed on the point display portion 201. Further, as shown at the right side of the middle stage of FIG. 1, a game number display portion 202 is provided in the liquid crystal panel 5B. In addition, a numerical value [1] is displayed on the game number display portion 202.

After that, whenever the unit game of the slot game is finished, the symbol [ATTACK] or [DAMAGE] is displayed on each of the display windows W1, W2, and W3, and the point amount that is calculated according to the number of each of displayed symbols [ATTACK] and [DAMAGE] is added and displayed on the point display portion 201. A numerical value [1] is added and is displayed on the game number display portion 202.

When the unit game of the slot game is repeated M1 times and a numerical value [M1] is displayed on the game number display portion 202, game-related information, which includes data that informs the point amount displayed on the point display portion 201 and the credit amount displayed on the credit amount display portion 9, is transmitted from the slot machine to the game server. In the liquid crystal panel 5B, an effect screen that broadcasts an actual moving picture of a boxing game is displayed, as shown at the left side of the middle stage of FIG. 1.

At this time, the game server compares the point amounts that are transmitted from the matched slot machines, and determines win/lose of a boxing game between the matched slot machines. In this case, the game server determines a slot machine that has the largest point amount as a winner and the other slot machines as losers. The game server further determines to confiscate the entire credit amount of the slot machines that have become losers. Meanwhile, the game server determines that the credit amount confiscated from the slot machines corresponding to losers is given to the slot machine that has become a winner. From the credit amount, the credit amount of several percents that are to be paid to a game arcade such as casino is excluded. The matched slot machines receive, from the game server, game-win/lose information that includes data informing execution of the determined items.

Then, the slot machine that has become a winner displays an effect screen, which is shown at the left side of the lower stage of FIG. 1, on the liquid crystal panel 5B. On the effect screen of the liquid crystal panel 5B that is shown at the left side of the lower stage of FIG. 1, [WIN! 375 Credits!] is displayed, which informs a corresponding player that the credit amount of [375] that has been owned by the slot machines determined as the losers is to be given to the slot machine determined as the winner. Although not shown in FIG. 1, as the following process, the given credit amount of [375] is added and displayed on the credit amount display portion 9 of the liquid crystal panel 5B.

Meanwhile, the slot machines that are determined as the losers display an effect screen, which is shown at the right side of the lower stage of FIG. 1, on the liquid crystal panel 5B. On the effect screen of the liquid crystal panel 5B that is shown at the right side of the lower stage of FIG. 1, [LOSE! 245 Credits!] is displayed, which informs corresponding players that the credit amount of [245] that has been owned by the slot machines determined as the losers is to be confiscated. Although not shown in FIG. 1, as the following process, a numerical value [0] is then displayed on the credit amount display portion 9 of the liquid crystal panel 5B.

In this way, if a player presses an entry button that is one of the operation buttons 11, the player can take part in a boxing game on which the entire credit amount that is owned by the slot machine of the player is bet. The boxing game is executed between the slot machines that are matched by the game server. Each slot machine calculates the point amount on the basis of the number of each of the symbols [ATTACK] and [DAMAGE] that are displayed on each of the display windows W1, W2, and W3 until a unit game of the slot game is repeated [M1] times after the entry button is pressed. Meanwhile, the game server determines a slot machine of a winner and slot machines of losers according to values of the calculated point amounts. In each of the slot machines that are determined as the losers, the entire credit amount that is owned by a corresponding player is confiscated at a point of time when the unit game of the slot game is repeated [M1] times after the entry button is pressed, and almost the entire confiscated credit amount is given to the slot machine determined as the winner.

[2. Schematic Structure of the Gaming System]

Hereinafter, one embodiment embodying the present invention is described with reference to the drawings.

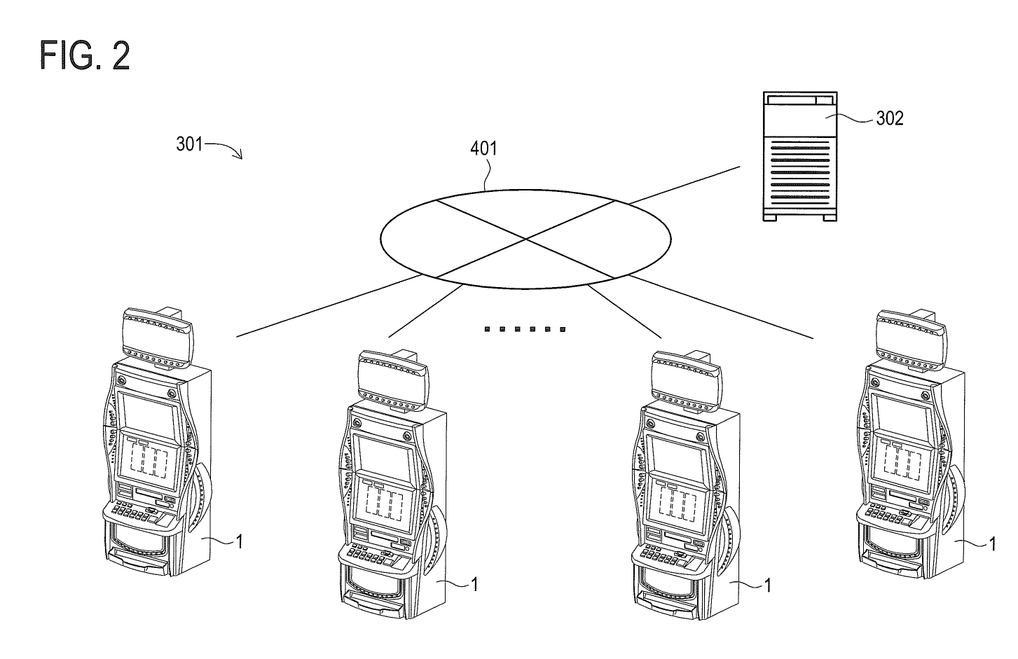

FIG. 2 is a system block diagram showing a gaming system 301 of the present embodiment. As shown in FIG. 2, the gaming system 301 of the present embodiment includes a network 401 of two-way communicable through which a game server 302 and a plurality of slot machines 1 are connected.

[3. Schematic Structure of Each Slot Machine]

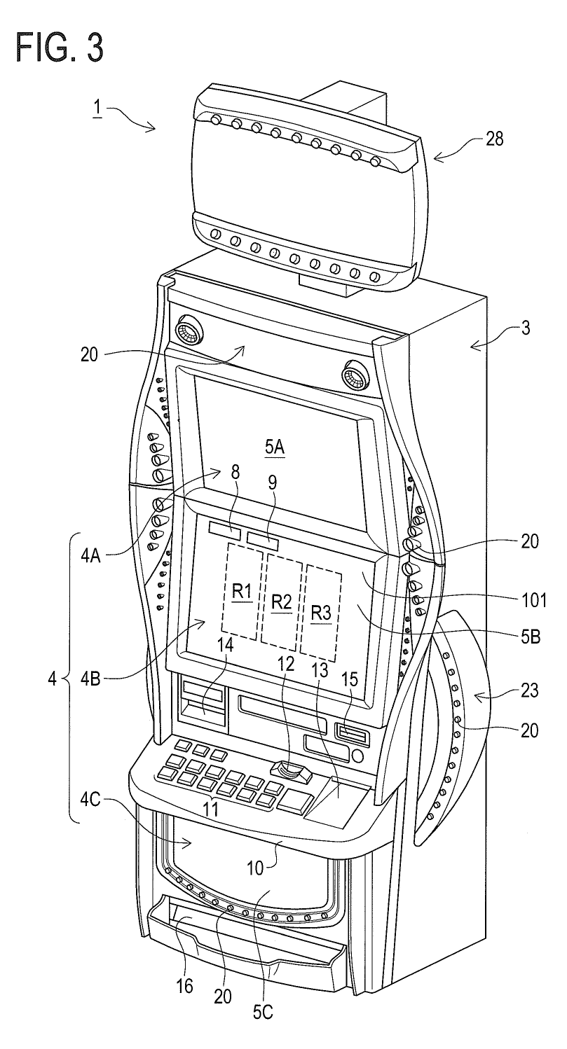

Next, a schematic structure of each slot machine 1 will be described by referring to FIG. 3. FIG. 3 is an external perspective view of each slot machine 1.

As shown in FIG. 3, each slot machine 1 is of an upright type which is equipped with a game arcade such as casino and includes a cabinet 3 for housing electric or mechanical parts for conducting predetermined types of games. A display unit 4 for displaying information related to a game includes, for example, an upper display unit 4A, a variable display unit 4B at the middle stage of the display unit 4, and an under display unit 4C, which are installed at the front face of the cabinet 3 in a vertically long shape. The upper display unit 4A includes a liquid crystal panel 5A arranged at the upper side of the variable display unit 4B, the liquid crystal panel 5A for displaying an effecting images, an introduction of a game, or an explanation of game rules and the like. The under display unit 4C is arranged at the lower side of the variable display unit 4B and includes a plastic panel 5C on which an image is printed. The plastic panel 5C is lighted up with the backlight of the under display unit 4C.

The variable display unit 4B for displaying a state of a game includes the liquid crystal panel 5B which is fixed at a front door of the cabinet 3. Through areas (that is, each display window W1, W2 and W3 in above FIG. 1) which are in a transparent state, the symbols of each mechanical reel R1, R2 and R3 arranged inside the cabinet 3, may be visible by the player. In the middle variable display portion 4B, one pay line L horizontally crossing each of areas corresponding to the mechanical reels R1, R1 and R3 is displayed on the liquid crystal display panel 5B. On the upper position of the middle variable display portion 4B, the payout amount display portion 8 and the credit amount display portion 9 are arranged on the liquid crystal panel 5B. Also the upper portion of the middle variable display portion 4B, is related to the back side, thereby the player may play games in a cozy posture.

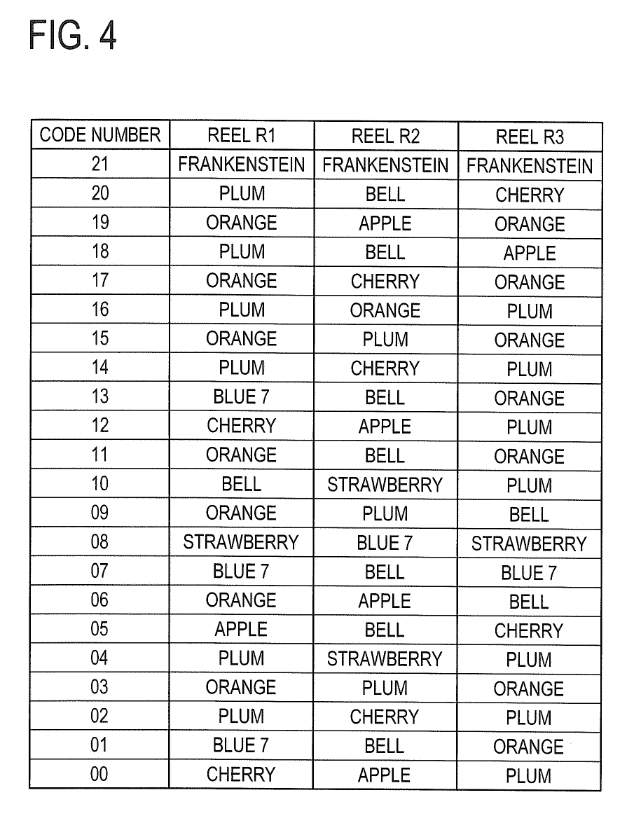

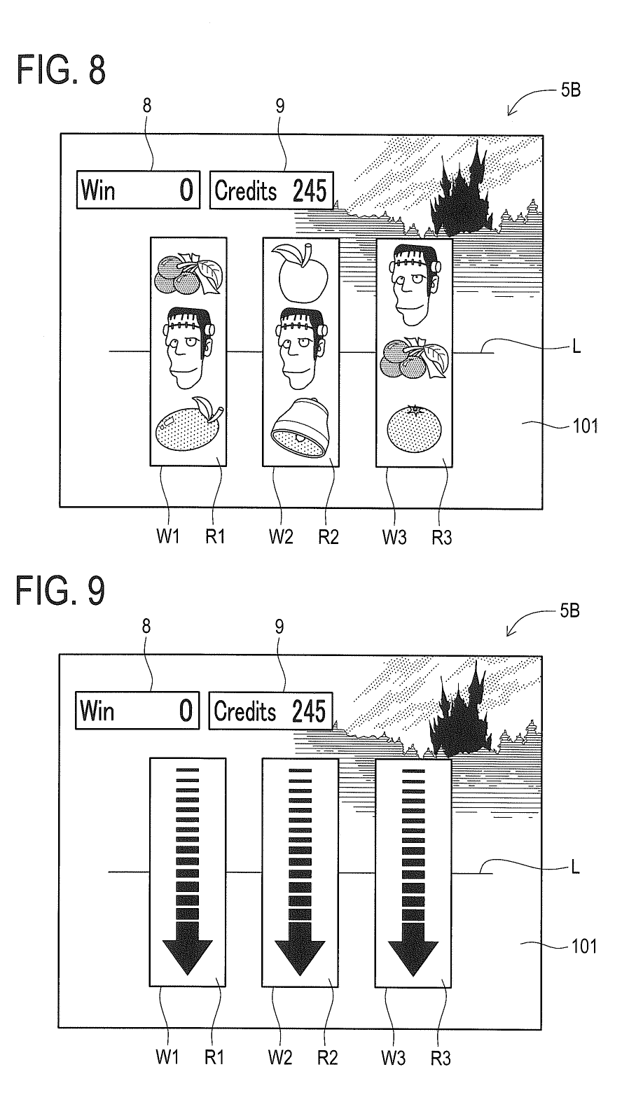

Here, the image of the slot game displayed on the liquid crystal panel 5B will be explained. FIG. 8 and FIG. 9 are the figures showing the contents displayed on the liquid crystal panel 5B. On the liquid crystal panel 5B, in the slot game, as shown in FIG. 8 and FIG. 9, each display window W1, W2 and W3 is changed to a transparent state, the symbols drawn on the reel band of each mechanical reel R1, R2 and R3 may be visible by the player. FIG. 8 shows the arranged or rearranged state of the symbols which are drawn on the reel band of each mechanical reel R1, R2 and R3, through each display window W1, W2 and W3 of the liquid crystal panel 5B. FIG. 9 shows the rotating state of the symbols which are drawn on the reel band of each mechanical reel R1, R2 and R3, through each display window W1, W2 and W3 of the liquid crystal panel 5B. On the reel band of each mechanical reel R1, R2 and R3, a symbol column constructed from twenty-two symbol is drawn respectively (refer to FIG. 4).

Also, in front of the liquid crystal panel 5B, the touch panel 101 is arranged, and the player may input his/her various instructions by operating the touch panel 101.

On the liquid crystal panel 5B, the payout amount display portion 8 and the credit amount display portion 9 are arranged. On the payout amount display portion 8, the payout amount obtained in the slot game by the player is displayed. On the credit amount display portion 9, the credit amount which is owned by the current player is displayed. Also, on the payout amount display portion 8, the payout amount obtained in the free game by the player is displayed.

Therefore, on the liquid crystal panel 5B in the slot game, each display window W1, W2 and W3 are changed to a transparent state, three symbols which are drawn on the reel band of each mechanical reel R1, R2 and R3 are visible through each display window W1, W2 and W3. On the liquid crystal panel 5B in the slot game, as shown in FIG. 8 and FIG. 9, the pay line L crossing each display window W1, W2 and W3 horizontally is displayed. The pay line L is used to specify the symbol combination.

Returning to FIG. 3, between the middle variable display portion 4B and the lower display portion 4C, at the front of the cabinet 3, an operation table 10 which is projected forward is arranged. On the operation table 10, a variety of operation buttons 11 including a BET button, a collecting button, a spin button, a CASHOUT button, a entry button are arranged as the operation portion to execute the game. On the operation table 10, a coin insertion slot 12 and a bill insertion portion 13 are arranged. Also between the operation table 10 and the middle variable display portion 4B, a ticket printer 14 and a card reader 15 are arranged. At the lowest position of the cabinet 3, a coin tray 16 is also arranged.

As to each slot machine 1, coins, bills or electronic value information (credit) corresponding to coins and bills are used as gaming media. However, in the present invention, types of gaming media are not restricted to the above. For example, medal, token, electronic money, ticket and the like are applicable as gaming media.

On the cabinet 3 of each slot machine 1, light emitting portions 20 are arranged around the game area including the upper display portion 4A, the middle variable display portion 4B, the lower display portion 4C and the operation table 10.

The slot machine 1 also includes a topper effect device 28 which is installed on the cabinet 3. The topper effect device 28 is shaped in a rectangular board shaped, and is arranged almost parallel to the liquid crystal panel 5A of the upper display portion 4A. The cabinet 3 is further provided with speakers 23 on its both sides.

[4. Schematic Symbols of the Mechanical Reel]

Next, the symbols drawn on the reel band of each mechanical reel R1, R2 and R3 will be explained with reference to FIG. 4. These symbols are scrolled and rearranged through each display window W1, W2 and W3 on the liquid crystal panel 5B during the slot game. FIG. 4 is a schematic view schematically showing symbol columns drawn on the reel band of each mechanical reel R1, R2 and R3.

On the reel band of each mechanical reel R1, R2 and R3, twenty-two symbols are drawn respectively. Each symbol column is constructed from the symbols including [FRANKENSTEIN], [BLUE7], [BELL], [APPLE], [CHERRY], [STRAWBERRY], [PLUM] and [ORANGE]. And the symbols of the predetermined types are arranged in a predetermined sequence.

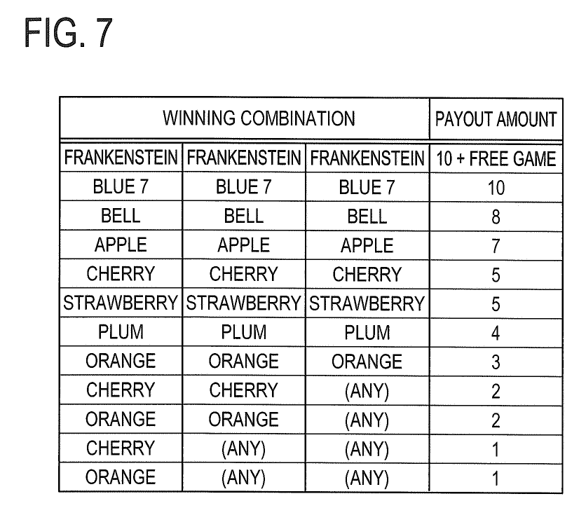

If three of any of the following symbols: [BLUE7], [BELL], [APPLE], [CHERRY], [STRAWBERRY], [PLUM] and [ORANGE] have been rearranged on the pay line L in the liquid crystal panel 5B, a payout amount obtained by multiplying a predetermined payout amount with a bet amount is awarded to a player (refer to FIG. 7). If one or two of symbols [CHERRY] or [ORANGE] have been rearranged on the pay line L in the liquid crystal panel 5B, a payout amount obtained by multiplying a predetermined payout amount with a bet amount is awarded to a player in accordance with the number of the rearranged symbols (refer to FIG. 7).

When three symbols of [FRANKENSTEIN] are rearranged on the pay line L in the liquid crystal panel 5B, a payout amount obtained by multiplying a predetermined payout amount with a bet amount is awarded to a player, and also the game shifts to a free game. In each symbol sequence shown in FIG. 4, a symbol number is allocated with respect to each symbol constituting these symbol columns, starting from the top.

[5. Internal Configuration of Each Slot Machine]

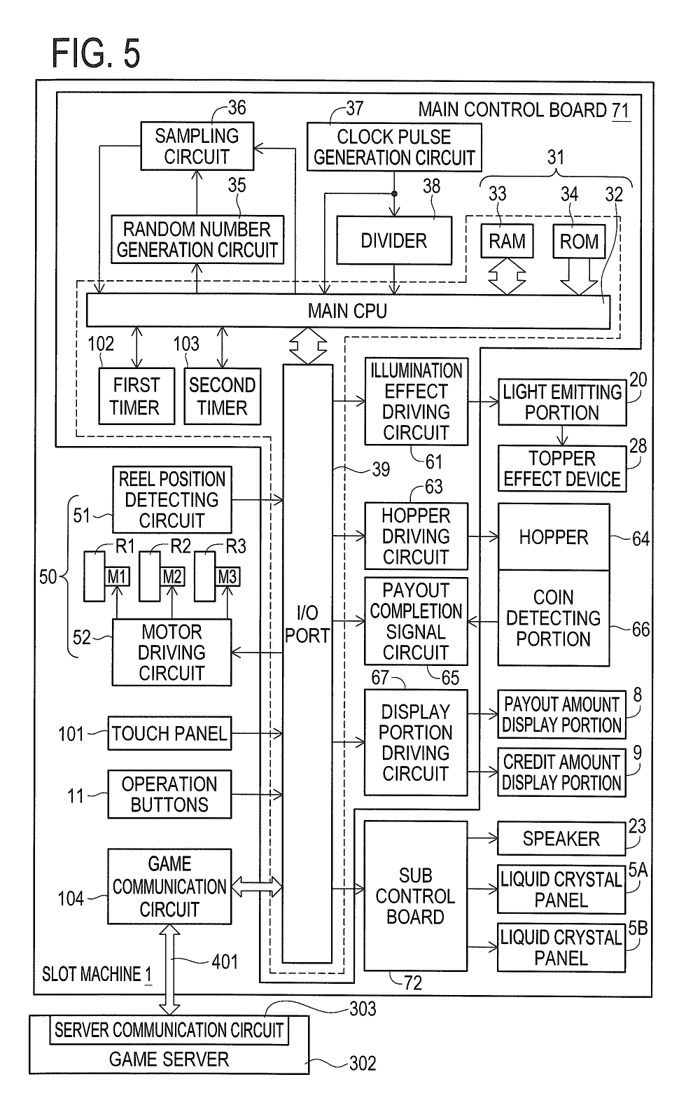

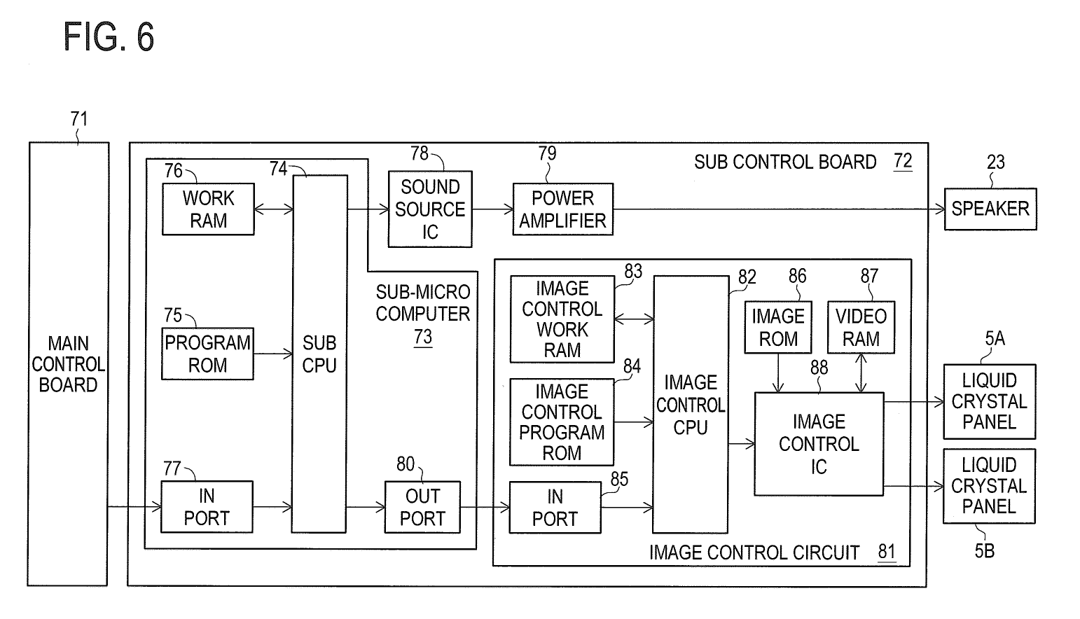

Next, the internal construction of the above slot machine 1 will be explained with reference to FIG. 5 and FIG. 6.

FIG. 5 is a block diagram schematically showing the internal construction of entire slot machine 1. As shown in FIG. 5, the slot machine 1 includes a plurality of construction elements such as a main control board 71, in which a microcomputer 31 is included. The main control board 71 is constructed from the microcomputer 31, a random number generation circuit 35, a sampling circuit 36, a clock pulse generation circuit 37 and a frequency divider 38. The main control board 71 also includes a first timer 102, a second timer 103, an illumination effect driving circuit 61, a hopper driving circuit 63, a payout completion signal circuit 65, a display portion driving circuit 67 and a game communication circuit 104.

The microcomputer 31 is constructed from a main CPU 32, a RAM 33 and a ROM 34. The main CPU 32 runs based on the programs stored in the ROM 34, and inputs/outputs signals with other elements through I/O port 39, so as to execute the control of the entire slot machine 1. Data and programs used when the main CPU 32 runs are stored in the RAM 33. For example, random numbers which are sampled by the after-mentioned sampling circuit 36 are stored temporarily after the start of the game, also the code numbers of each mechanical reel R1, R2 and R3, the symbol numbers are stored in the RAM 33. Also, the after-mentioned each variable, the code numbers of the after-mentioned each video reel V1, V2 and V3, the symbol numbers and the like are stored in the RAM 33. And the programs executed by the main CPU 32 and the permanent data are stored in the ROM 34.

Especially, the programs stored in the ROM 34 include the game programs and the gaming system programs (abbreviated as [the game programs and the like] hereinafter). And a lottery programs mentioned below is also included in the game programs.

The lottery program is a program used to determine the code numbers of each mechanical reel R1, R2 and R3 which corresponds to each symbol rearranged on the pay line L in the liquid crystal panel 5B. In the lottery program, it is included symbol weighing data corresponding to each of plural kinds of payout rates (for example, 80%, 84%, and 88%). The symbol weighing data are the data indicating correlation between the code number of each reel and one or plural random numbers belonging to a predetermined number range (0 to 255), every each of the three mechanical reels R1, R2 and R3. In other words, each of the code number of one reel is associated with one or more random numbers corresponding to the payout rate. The random number is extracted by the lottery program, and the symbol specified finally by the random number is rearranged on the pay line L in the liquid crystal panel 5B.

Random numbers over a predetermined range are generated by the random number generation circuit 35, which is operated based on the instructions from the main CPU 32. The random numbers are voluntarily extracted from the random numbers generated by the random number generation circuit 35 by the sampling circuit 36, based on the instructions from the main CPU 32, and the extracted random numbers are input to the main CPU 32. The base clock for running the main CPU 32 is generated by the clock pulse generation circuit 37, and the signals which are generated by dividing the base clock in a predetermined frequency are input to the main CPU 32 by the frequency divider 38.

And to the main control board 71, a reel driving unit 50 is connected. The reel driving unit 50 includes a reel position detection circuit 51 which detects the positions of the mechanical reels R1, R2 and R3, and a motor driving circuit 52 which inputs the driving signals to the motors M1, M2 and M3 which are used to rotate the mechanical reels R1, R2 and R3. The motors M1, M2 and M3 are operated based on the driving signals input from the motor driving circuit 52, and rotate the mechanical reels R1, R2 and R3, and stop the mechanical reels R1, R2 and R3 at a desired position.

Furthermore, the touch panel 101 is connected to the main control board 71. The touch panel 101 is arranged in front of the liquid crystal panel 5B, and specifies the coordinate position of the portion touched by the player. The position on which the player touched and the direction of the movement of the touched portion are determined based on the specified coordinate position information. And the signals corresponding to the determination are input to the main CPU 32 through I/O port 39.

Also, the operation buttons 11 for instructing the execution of the game are connected to the main control board 71. The operation buttons 11 include the spin button, the collecting button, the BET button, the entry button and the like. The signals corresponding to the pressing of these buttons are input to the main CPU 32 through I/O port 39.

The first timer 102 and the second timer 103 input into the main CPU 32 a signal notifying when a setting time is over.

The effect signals which are used to conduct illumination effect are output to the above-mentioned light emitting portion 20 and topper effect device 28 by the illumination effect driving circuit 61. And the topper effect device 28 is serially connected to the illumination effect driving circuit 61 through light emitting portions 20.

A hopper 64 is driven by the hopper driving circuit 63 based on the control of main CPU 32. The hopper 64 executes the payout of coins, and coins are paid out from the coin tray 16. The data of the number of coins are input from the connected coin detecting portion 66 by the payout completion signal circuit 65. When the number of coins becomes a predetermined number, the signal indicating the completion of the coins is input to the main CPU 32. The number of the coins paid out from the hopper 64 is calculated by the coin detecting portion 66, and the data of the number calculated are input to the payout completion signal circuit 65. The display operation of the payout amount display portion 8 and credit amount display portion 9 is controlled by the display portion driving circuit 67.

The game communication circuit 104 is a device that converts a signal sent to be sent out by the slot machine 1 into a signal in a sendable format, according to transmission method of a phone line or a LAN cable, so as to send it to the game server 302. Conversely, the game communication circuit 104 receives a signal sent from the game server 302 to reconvert the signal into a signal in a format readable by the slot machine 1. The game communication circuit 104 is connected to a server communication circuit 303 via the network 401 of two-way communicable, such as the Internet.

Furthermore, a sub control board 72 is connected to the main control board 71. As shown in FIG. 6, commands from the main control board 71 are input to the sub control board 72. The display control on the liquid crystal panel 5A of the upper display portion 4A and the liquid crystal panel 5B of the variable display portion 4B, and the sound output control on the speaker 23 are executed by the sub control board 72. The sub control board 72 is constructed on a circuit board different from the circuit board for the main control board 71, and includes a microcomputer 73 (abbreviated as [sub-microcomputer] hereinafter) as a main construction element, and a sound source IC 78, a power amplifier 79 and an image control circuit 81. The sound source IC 78 controls the sound output from the speaker 23, the power amplifier 79 is used as an amplification device, and the image control circuit 81 is used as the display control device of the liquid crystal panel 5A and 5B.

The sub-microcomputer 73 includes a sub CPU 74, a program ROM 75, a work RAM 76, an IN port 77 and an OUT port 80. The control operations are executed by sub CPU 74 based on the control order transmitted from the main control board 71, the program ROM 75 is used as a memory device. Although a clock pulse generation circuit, a frequency divider, a random number generation circuit and a sampling circuit are not included in the sub control board 72, the sub control board 72 is constructed so as to execute random number sampling according to the operation programs thereof. The control programs executed by the sub CPU 74 are stored in the program ROM 75. The work RAM 76 is constructed as a temporary storing means when the above control programs are executed by the sub CPU 74.

The image control circuit 81 includes an image control CPU 82, an image control work RAM 83, an image control program ROM 84, an IN port 85, an image ROM 86, a video RAM 87 and an image control IC 88. The images displayed on the liquid crystal panel 5A and 5B are determined by the image control CPU 82, based on the parameters set by the sub-microcomputer 73, according to the image control programs stored in the image control program ROM 84.

The image control programs regarding to the display of the liquid crystal panel 5A, 5B and a variety of the selection tables are stored in the image control program ROM 84. The image control work RAM 83 is constructed as a temporary storing means when the image control programs are executed by image control CPU 82. Images corresponding to the content determined by the image control CPU 82 are formed by the image control IC 88, and are output to the liquid crystal panel 5A, 5B.

In the image ROM 86, the dot data used to form images are stored. Therefore, the dot data related to the symbols drawn on the reel band of the after-mentioned each video reel V1, V2 and V3 are stored in the image ROM 86. The video RAM 87 runs as a temporary storing means when the images are formed by the image control IC 88.

[6. Outline of the Slot Game]

Next, winning combinations and the payout amounts corresponding to the winning combinations will be explained with reference to FIG. 7, wherein the winning combinations are the symbol combinations when the slot game is executed by using each mechanical reel R1, R2 and R3 in each slot machine 1. FIG. 7 is a payout table in which the winning combinations and the payout amounts corresponding to the winning combinations are shown when the slot game is executed by using each mechanical reel R1, R2 and R3 in each slot machine 1.

Here, the payout amount shown in FIG. 7 indicates the payout amount when the bet amount is [1] in the slot game. Therefore, when the bet amount is [1], the payout amount shown in FIG. 7 is awarded, and when the bet amount is more than [2], the payout amount obtained by multiplying the payout amount shown in FIG. 7 with the bet amount is awarded.

Thereby, when three symbols of [FRANKENSTEIN] are rearranged on the pay line L in the liquid crystal panel 5B, the payout amount obtained by multiplying 10 credits with the bet amount is awarded. Additionally, the bonus trigger is realized, the free game is generated. Also, in the free game, the bonus trigger may be realized, at that time, a new free game is generated.

When three symbols of [BLUE 7] are rearranged on the pay line L in the liquid crystal panel 5B, the payout amount obtained by multiplying 10 credits with the bet amount is awarded.

When three symbols of [BELL] are rearranged on the pay line L in the liquid crystal panel 5B, the payout amount obtained by multiplying 8 credits with the bet amount is awarded.

The payout amount corresponding to each winning combination shown in FIG. 7, are set as the same in the above. However, when a symbol combination constructed from the symbols rearranged on the pay line L in the liquid crystal panel 5B, is not any of the winning combinations shown in FIG. 7, the symbol combination is not a winning combination. Therefore, no credits may be awarded.

As mentioned above, in each slot machine 1, the slot game and the free game is executed.

In other words, in the slot game, a game is executed by rearranging a specific symbol combination by using each mechanical reel R1, R2 and R3 on the pay line L in the liquid crystal panel 5B. In the slot game, firstly, a part of symbol column (three symbols) drawn on the reel band of each mechanical reel R1, R2 and R3 shown in FIG. 4, is arranged on the liquid crystal panel 5B through each transparent display window W1, W2 and W3 (refer to FIG. 8). Here, after the player sets the bet amount by pressing the BET button among the operation buttons 11, if the player presses the spin button among the operation buttons 11, each mechanical reel R1, R2 and R3 rotates, the symbol column drawn on the reel band of each mechanical reel R1, R2 and R3 shown in FIG. 4, is scrolled from up to down and displayed on the liquid crystal panel 5B, through each transparent display window W1, W2 and W3 (refer to FIG. 9).

After a predetermined time, each mechanical reel R1, R2 and R3 stops automatically, a part of the symbol column (three symbols) drawn on the reel band of each mechanical reel R1, R2 and R3 shown in FIG. 4, is rearranged on the liquid crystal panel 5B through each transparent display window W1, W2 and W3 (refer to FIG. 8). On the other hand, each winning combination based on each symbol combination is determined beforehand (refer to FIG. 7). When the symbol combination constructed from the three symbols rearranged on the pay line L in the liquid crystal panel 5B, realizes a winning combination, the payout amount obtained by multiplying the payout amount corresponding to the realized winning combination with the bet amount is awarded to the player.

On the other hand, in the free game, the game, in which a specific symbol combination is rearranged by using each mechanical reel R1, R2 and R3 on the pay line L in the liquid crystal panel 5B, is repeated over a predetermined number of times. Also, in the free game, a part of the symbol column (three symbols) drawn on the reel band of each mechanical reel R1, R2 and R3 as shown in FIG. 4, is arranged on the liquid crystal panel 5B through each transparent display window W1, W2 and W3 (refer to FIG. 8). However, here, after a predetermined time, each mechanical reel R1, R2 and R3 rotates automatically. Thereby, no matter whether the player presses the operation buttons 11 such as the BET button or the spin button, the symbol column drawn on the reel band of each mechanical reel R1, R2 and R3 as shown in FIG. 4 is scrolled from up to down and displayed on the liquid crystal panel 5B, through each transparent display window W1, W2 and W3 (refer to FIG. 9).

Furthermore, after a predetermined time, each mechanical reel R1, R2 and R3 stops automatically, a part of the symbol column (three symbols) drawn on the reel band of each mechanical reel R1, R2 and R3 as shown in FIG. 4, is rearranged on the liquid crystal panel 5B through each transparent display window W1, W2 and W3 (refer to FIG. 8). On the other hand, similar to the above slot game, each kind of winning combination is determined beforehand based on the symbol combination (refer to FIG. 7). When the symbol combination, which is constructed from the three symbols rearranged on the pay line L in the liquid crystal panel 5B, realizes a winning combination, the payout amount obtained by multiplying the payout amount corresponding to the realized winning combination with the bet amount is awarded to the player.

The predetermined number of times for the free game (for example, 20 times) is set in advance.

[7. Outline of the Boxing Game]

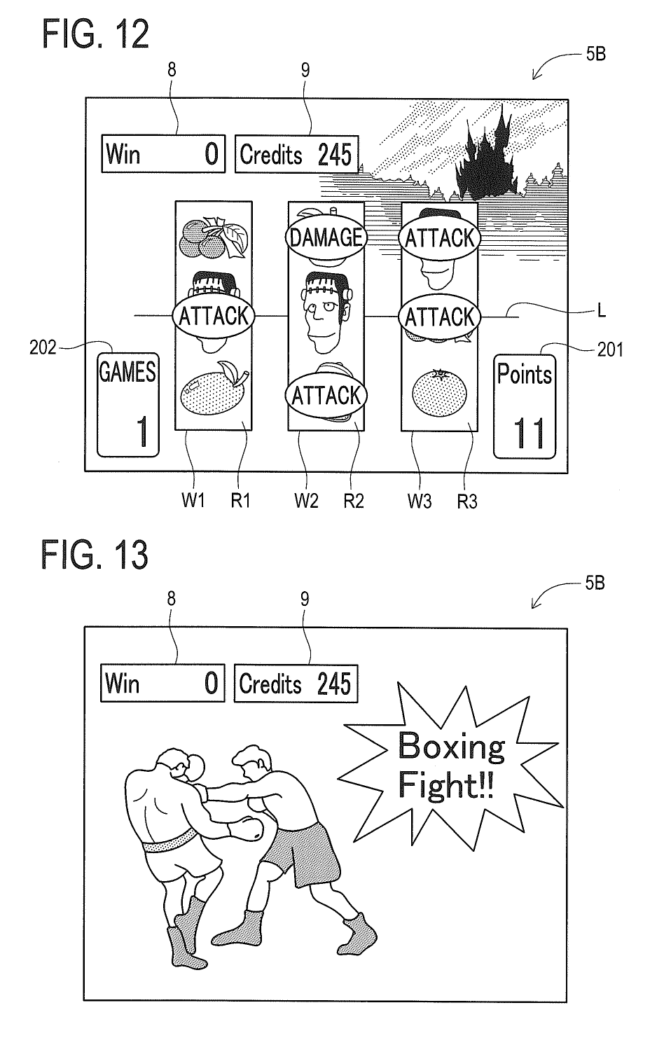

As described above, when a player of the corresponding slot machine 1 presses the entry button that is one of the operation buttons 11, a boxing game is executed in parallel with the slot game. In the liquid crystal panel 5B during the boxing game, a symbol [ATTACK] or [DAMAGE] is displayed on each of the display windows W1, W2, and W3 in a transparent state, as shown in FIG. 12.

At this time, in the display windows W1, W2, and W3 in a transparent state, three video reels where reel bands are transparently displayed except for symbols [ATTACK] and [DAMAGE] drawn on the reel bands are rotation-displayed and stopped, respectively, and thus the symbol [ATTACK] or [DAMAGE] is displayed.

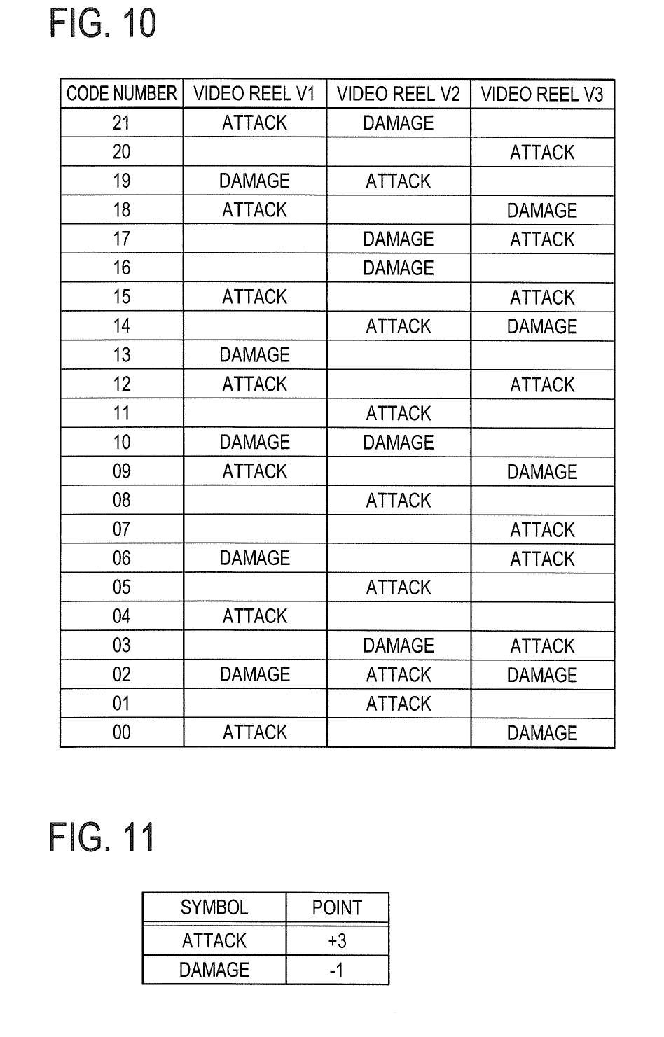

Hereinafter, with reference to FIG. 10, a description will be given of symbols that are drawn on reel bands of video reels V1, V2, and V3, and scrolled and rearranged in the display windows W1, W2, and W3 of the liquid crystal panel 5B when the boxing game is executed. FIG. 10 is a schematic diagram illustrating symbol columns that are drawn on the reel bands of the video reels V1, V2, and V3. 22 symbols are drawn on the reel bands of each of the video reels V1, V2, and V3. Each symbol column is configured by a combination of symbols [ATTACK] and [DAMAGE] including blanks. In addition, the predetermined types of symbols are arranged in the predetermined order. In FIG. 10, nothing is displayed in places of the blanks.

In each symbol sequence shown in FIG. 10, a symbol number is allocated with respect to each symbol constituting these symbol columns, starting from the top.

If the symbols [ATTACK] and [DAMAGE] are displayed on each of the display windows W1, W2, and W3 of the liquid crystal panel 5B, the point amount is calculated on the basis of a table shown in FIG. 11. The table that is shown in FIG. 11 is stored in a ROM 34 or a RAM 33 of the slot machine 1, and the main CPU 32 refers to the table. The table shown in FIG. 11 is specifically described. If the symbol [ATTACK] is displayed on each of the display windows W1, W2, and W3 of the liquid crystal panel 5B, the point amount of [+3] is given whenever the corresponding symbol is displayed. Further, if the symbol [DAMAGE] is displayed on each of the display windows W1, W2, and W3 of the liquid crystal panel 5B, the point amount of [−1] is given whenever the corresponding symbol is displayed.

In other words, the boxing game is started in parallel with the slot game after a player of the slot machine 1 presses the entry button that is one of the operation buttons 11, as shown in the liquid crystal panel 5B of FIG. 12. In this case, when the unit game of the slot game is finished, the video reels V1, V2, and V3 that have transparent reel bands except for the symbols [ATTACK] and [DAMAGE] drawn on the reel bands are rotated and stopped. As a result, the symbol [ATTACK] or [DAMAGE] is displayed on each of the display windows W1, W2, and W3. At this time, on the basis of the table that is shown in FIG. 11, a point of [+3] is given to one symbol [ATTACK], and a point of [−1] is given to one symbol [DAMAGE].

As shown in FIG. 12, the point display portion 201 is provided in the liquid crystal panel 5B. In addition, the point amount according to the number of each of the displayed symbols [ATTACK] and [DAMAGE] is calculated on the basis of the table shown in FIG. 11, and the calculated point amount is displayed on the point display portion 201. As shown in FIG. 12, the game number display portion 202 is provided in the liquid crystal panel 5B. In addition, a numerical value [1] is displayed on the game number display portion 202.

After that, whenever the unit game of the slot game is finished, each of the video reels V1, V2, and V3 is rotated and stopped, and thus the symbol [ATTACK] or [DAMAGE] is displayed on each of the display windows W1, W2, and W3. In addition, the point amount that is calculated according to the number of each of the displayed symbols [ATTACK] and [DAMAGE] is added and displayed on the point display portion 201, and a numerical value [1] is added and displayed on the game number display portion 202.

When the unit game of the slot game is repeated [M1] times and a numerical value [M1] is displayed on the game number display portion 202, the game-related information, which includes data that informs the point amount displayed on the point display portion 201 and the credit amount displayed on the credit amount display portion 9, is transmitted from the slot machine 1 to the game server 302. Further, in the liquid crystal panel 5B of the slot machine 1, an effect screen that broadcasts an actual moving picture of a boxing match is displayed, as shown in FIG. 13.

At this time, the game server 302 compares the point amounts that are transmitted from the matched slot machines 1, and determines win/lose of a boxing game between the matched slot machines 1. In this case, the game server 302 determines the slot machine 1 that has the largest point amount as a winner and each of the other slot machines 1 as a loser. The game server 302 further determines to confiscate the entire credit amount of the slot machines 1 that have become a loser. Meanwhile, the game server 302 determines that the credit amount confiscated from the slot machines 1 corresponding to losers is given to the slot machine 1 that has become a winner. From the credit amount, the credit amount of several percents that are to be paid to a game arcade such as casino is excluded. The matched slot machines 1 receive, from the game server 302, game-win/lose information that includes data informing that the determined items are executed.

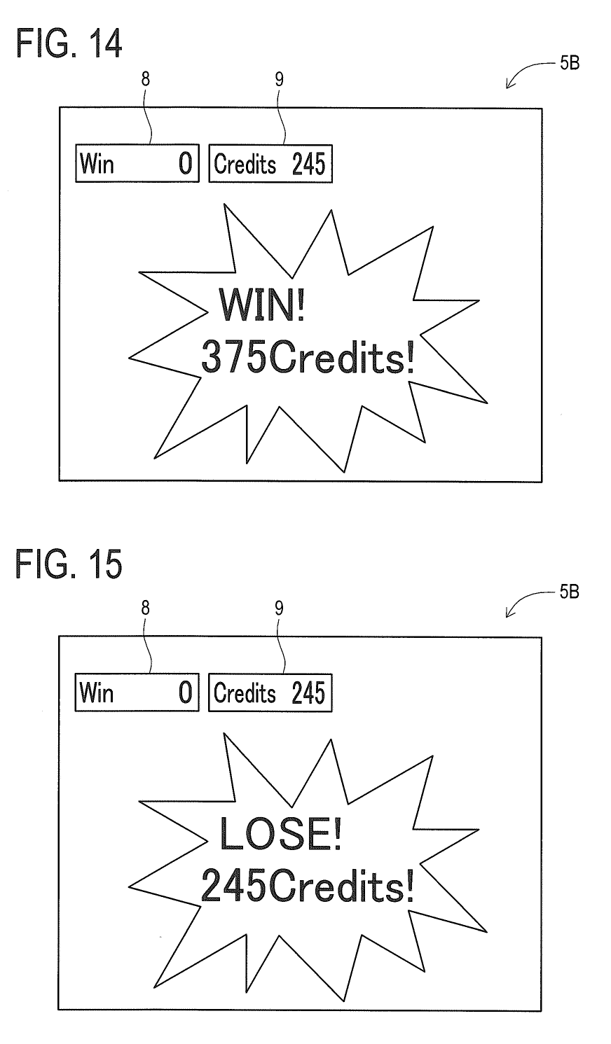

Then, the slot machine 1 that has become a winner displays an effect screen such as shown in FIG. 14 on the liquid crystal panel 5B. On the effect screen of the liquid crystal panel 5B that is shown in FIG. 14, [WIN! 375 Credits!] is displayed, which informs a corresponding player that the credit amount of [375] that has been owned by the slot machines 1 determined as the losers is to be given to the slot machine determined as the winner. Although not shown in FIG. 14, as the following process, the given credit amount of [375] is added and displayed in the credit amount display portion 9 of the liquid crystal panel 5B.

Meanwhile, the slot machines 1 that are determined as the losers display the effect screen such as shown in FIG. 15 on the liquid crystal panel 5B. On the effect screen of the liquid crystal panel 5B that is shown in FIG. 15, [LOSE! 245 Credits!] is displayed, which informs corresponding players that the credit amount of [245] that has been owned by the slot machines 1 determined as the losers is to be confiscated. Although not shown in FIG. 15, as the following process, a numerical value [0] is displayed on the credit amount display portion 9 of the liquid crystal panel 5B.

### [8. Operation of Each Slot Machine]

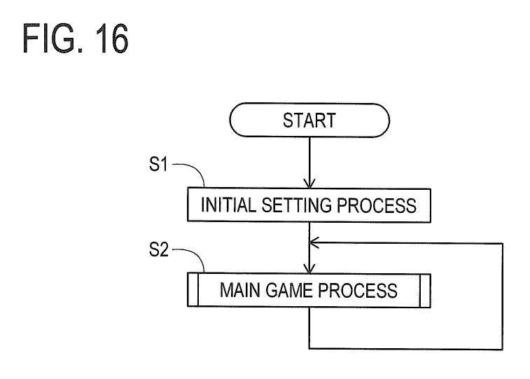

Next, a main control program executed in each slot machine 1 will be explained with reference to figures. FIG. 16 is a flowchart of the main control program.

First, when the power switch is pressed, the microcomputer 31 is started to operate, an initialization is executed by the microcomputer 31 in step (abbreviated as [S]) 1. In an initial setting process, the BIOS stored in the ROM 34 is executed by the main CPU 32. The compressed data included in the BIOS is expanded to the RAM 33, and when the BIOS expansion to the RAM 33 is executed, the diagnosing and initialization process of the various peripheral devices are executed. Also, the game programs and the like are written from the ROM 34 to the RAM 33 by the main CPU 32, so as to obtain the payout rate setting data and the country ID information. Also, during the execution of the initial setting process, the verification process to each program is executed. Also, during the execution of the initial setting process, the main CPU 32 substitutes for each variable [0].

And in S2, the main CPU 32 reads out the game programs and the like from the RAM 33, and executes the programs in sequence so as to execute a main game process. The game is executed in each slot machine 1 by executing the main game process. And the main game process is repeated in the slot machine 1 when the power is supplied to the slot machine 1.

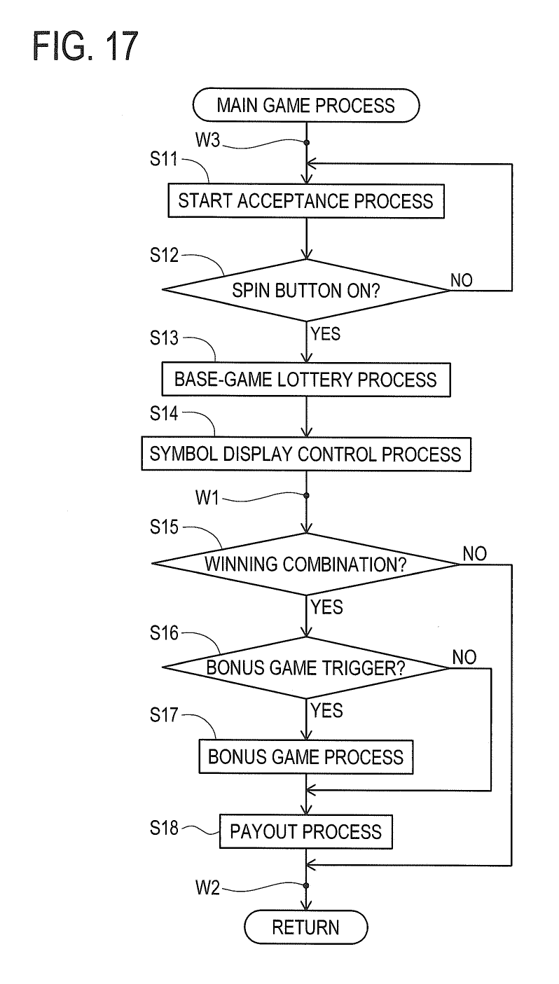

Next, sub process of the main game process in S2 will be explained with reference to FIG. 17. FIG. 17 is a flowchart of the main game process program in each slot machine 1. Also, each program shown in the flowchart of FIG. 17 is stored in the ROM 34 or the RAM 33 of each slot machine 1, and is executed by the main CPU 32.

First, as shown in FIG. 17, a start acceptance process is executed by the main CPU 32 in S11. At this time, in the start acceptance process, the insertion of the coins or the bet operation using the BET button among the operation buttons 11 is executed by the player. And the control signals are transmitted to the sub control board 72 by the main CPU 32, so that each display window W1, W2 and W3 of the liquid crystal panel 5B is shift/maintained in a transparent state.

And then, it is determined by the main CPU 32 whether the spin button among the operation buttons 11 is pressed in S12. It is determined based on the input signals corresponding to the button pressing of the operation button 11 to the main CPU 32. Here, when the spin button among the operation buttons 11 is not pressed (S12: NO), the flow returns to the start acceptance process (S11) again. Thereby, it is possible to change the bet amount and the like. On the other hand, when the spin button among the operation buttons 11 is pressed (S12: YES), the bet amount set based on the above bet operation is reduced from the credit amount owned by the player at that time, and is stored in the RAM 33 as bet information. And the credit amount after reduction is also stored in the RAM 33 as credit information. And then, the control signals are transmitted to the display portion driving circuit 67 by the main CPU 32, the credits information stored in the RAM 33 (the above credit amount after reduction) is displayed on the credit display portion 9 of the liquid crystal panel 5B.

In S13, a base-game lottery process is executed by the main CPU 32. Concretely, when the lottery program included in the game programs is executed by the main CPU 32, the random number corresponding to each mechanical reel R1, R2 and R3 respectively is selected from a range of [0] to [255]. And with reference to the symbol weighing data corresponding to the payout rate setting data, based on the three random numbers, the code numbers of the respective mechanical reels R1, R2 and R3 is determined. The determined code numbers of the respective mechanical reels R1, R2 and R3 is stored in the RAM 33 by the main CPU 32, and the flow proceeds to S14.

Here, the code numbers of the respective mechanical reels R1, R2 and R3 are associated with the symbol numbers (symbol numbers shown in FIG. 4) of the symbols which are rearranged on the pay line L in the liquid crystal panel 5B. The main CPU 32 determines the symbol combination in the unit game by determining the code numbers of the respective mechanical reels R1, R2 and R3. For instance, if the symbol numbers of the respective mechanical reels R1, R2 and R3 are set to [21], [21] and [21], the main CPU 32 decides for a symbol combination made up of three [FRANKENSTEIN] symbols (refer to FIG. 4), as the symbol combination in the unit game. Lottery for the symbol combination in the unit game of the slot game is carried out by determining the code numbers of the respective mechanical reels R1, R2 and R3.

When the flow proceeds to S14, a symbol display control process is executed by the main CPU 32. Concretely, first, a reel rotation process is executed by the main CPU 32. In other words, each motor M1, M2 and M3 is driven by the main CPU 32 through the motor driving circuit 52, so as to rotate each mechanical reel R1, R2 and R3. And then, the effect mode (the display mode of the images on the liquid crystal panel 5B and the sound output mode from the speaker 23) for each unit game is determined by the main CPU 32, and the sub control board 72 is ordered to start the effect in a predetermined effect pattern. And then, when the predetermined stop timing to stop each mechanical reel R1, R2 and R3 comes, a reel stop process is executed by the main CPU 32 through the motor driving circuit 52, thereby each mechanical reel R1, R2 and R3 is stopped based on the code numbers stored in the RAM 33. Thereby, the symbol combination, which was determined in the above S13, is rearranged on the pay line L in the liquid crystal panel 5B.

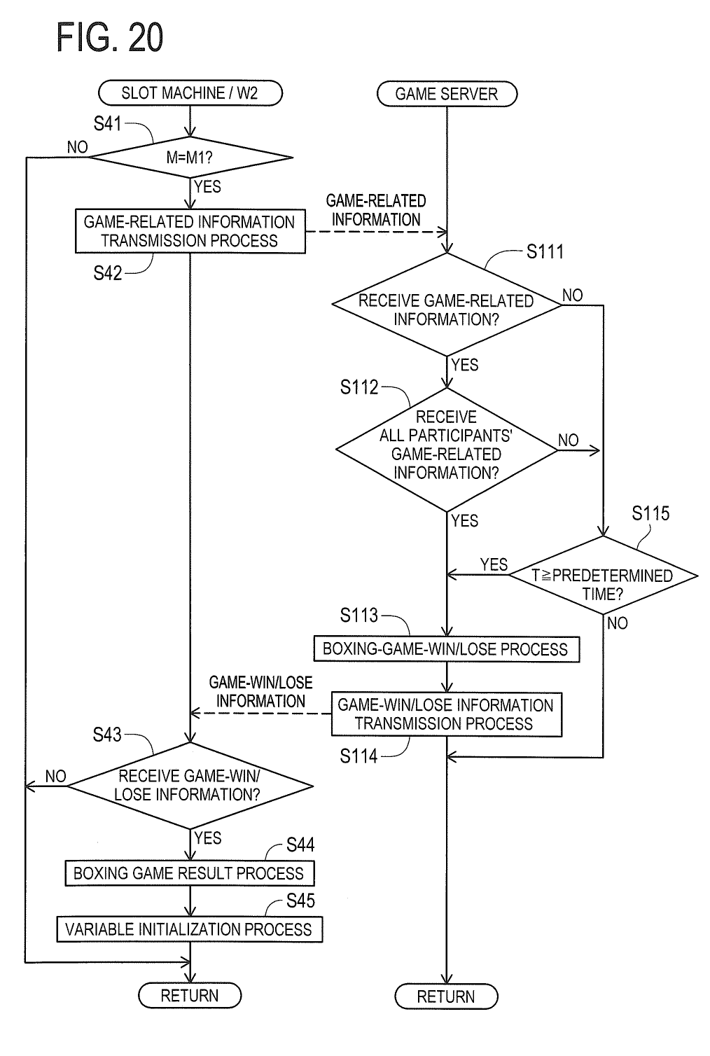

Then, the main CPU 32 proceeds to S15, at which it determines whether or not a winning combination has been realized. This determination is made based on the code numbers of the respective mechanical reels R1, R2 and R3 that were stored in the RAM 33. If a winning combination has not been realized (S15: NO), the flow proceeds to S41 in FIG. 20 as described below. Alternatively, if a winning combination has been realized (S15: YES), the flow proceeds to S16.

Also, in S15, the main CPU 32 executes a payout amount display process. More specifically, first, the main CPU 32 calculates an amount obtained by multiplying the payout amount in accordance with the winning combination rearranged on the pay line L in the liquid crystal panel 5B, by the bet amount. This calculation is made based on the bet information stored in the RAM 33 and the payout table in FIG. 7, the calculated amount is stored in the RAM 33 as payout information. Then, the main CPU 32 displays the payout information (calculated amount) stored in the RAM 33 on the payout amount display portion 8 of the liquid crystal panel 5B, by transmitting a control signal to the display portion driving circuit 67.

Then, the main CPU 32 proceeds to S16, at which it judges whether or not the bonus game trigger is realized. More specifically, if three [FRANKENSTEIN] symbols are rearranged on the pay line L in the liquid crystal panel 5B, it is determined that the bonus game trigger is realized. This determination as well is carried out based on the code numbers of the respective mechanical reels R1, R2 and R3 stored in the RAM 33. If the bonus game trigger is realized (S16: YES), the main CPU 32 executes a bonus game process in S18. The bonus game process will be described in detail later.

After that, the main CPU 32 executes a payout process is S18, including the case when the bonus game trigger is not realized (S16: NO). In the payout process, the payout amount obtained by the player in the slot game and the bonus game (the free game), is awarded to the player respectively, based on the payout information stored in the RAM 33.

When the payout is executed, the credit amount which are stored in the RAM 33 as the payout information (the payout amount obtained by the player in the base game and the free game respectively) are added to the credit amount stored in the RAM 33 as the credit information by the main CPU 32, and the added value is overwritten in the RAM 33 as the credit information by the main CPU 32. And then, the control signals are transmitted to the display portion driving circuit 67 by the main CPU 32, the credits information stored in the RAM 33 (the added value in S18) is displayed on the credit display portion 9 of the liquid crystal panel 5B. At the same time, [0] is overwritten to the RAM 33 as the payout information by the main CPU 32, and by transmitting the control signals to the display portion driving circuit 67, on the payout amount display portion 8 of the liquid crystal panel 5B, [0] is displayed.

In this payout process, when the player depresses the CASHOUT button among the operation buttons 11, the credit amount which is owned by the current player can be paid out in coins, corresponding to that amount (1 credit corresponding to 1 coin). Alternatively, the credit amount can be paid out through barcode-attached tickets which are printed in the ticket printer 14. Then, after the main CPU 32 executed the payout process in the above S18, the flow proceeds to S41 in FIG. 20 as described below.

[9. Operation of the Gaming System]

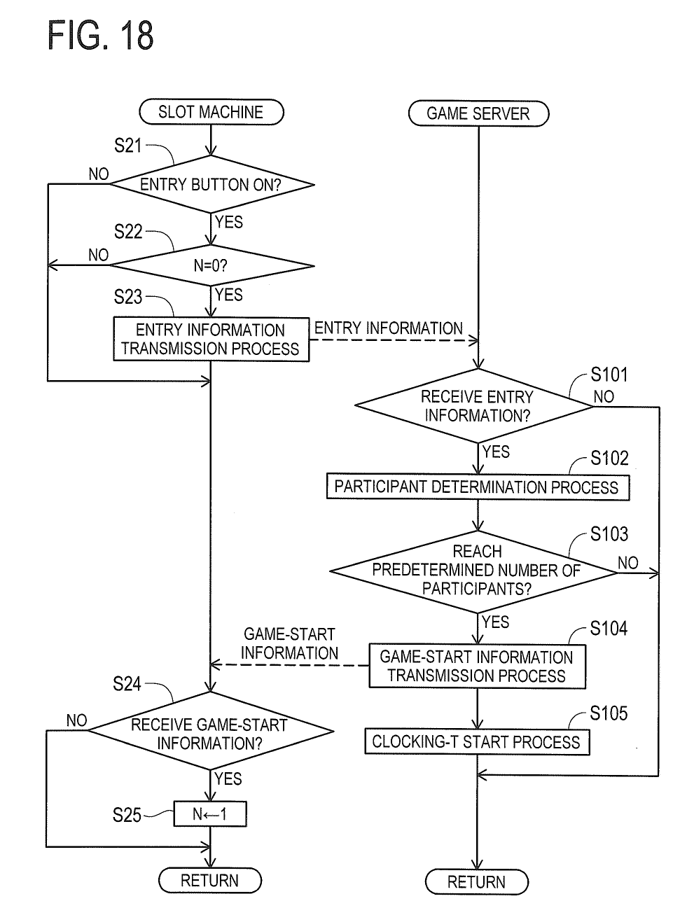

After executing the main game process of FIG. 17, the main CPU 32 executes each of processes of S21 to S25 shown in FIG. 18. Accordingly, the processes of S21 to S25 will be described with reference to FIG. 18. Each of programs shown by S21 to S25 in FIG. 18 is stored in the ROM 34 or the RAM 33 of each slot machine 1, and executed by the main CPU 32.

First, as shown in FIG. 18, in S21, the main CPU 32 determines whether the entry button that is one of the operation buttons 11 is pressed or not. This determination is executed on the basis of a signal that is input to the main CPU 32 when the entry button is pressed. In this case, when it is determined that the entry button that is one of the operation buttons 11 is not pressed (S21:NO), the flow proceeds to S24. On the other hand, when it is determined that the operation button 11 that is one of the operation buttons 11 is pressed (S21:YES), the flow proceeds to S22.

In S22, the main CPU 32 determines whether a variable N that is stored in the RAM 33 is [0] or not. In this case, when it is determined that the variable N is not [0] (S22: NO), the flow proceeds to S24. When it is determined that the variable N is [0] (S22: YES), on the other hand, the flow proceeds to S23.

In S23, the main CPU 32 executes an entry information transmission process. During the entry information transmission process, the main CPU 32 transmits entry information, which includes data informing that the slot machine 1 takes part in the boxing game, to the game server 302 through the game communication circuit 104. At the same time, the main CPU 32 overwrites [0] as point information (point amount) in the RAM 33. Then, the flow proceeds to S24.

In S24, the main CPU 32 determines whether game-start information is received from the game server 302. This determination is executed on the basis of a signal that is input from the game communication circuit 104 to the main CPU 32 when the game-start information is received from the game server 302. In this case, when it is determined that the game-start information is not received (S24:NO), the main CPU 32 executes the above main game process of FIG. 17 again. When it is determined that the game-start information is received (S24:YES), on the other hand, the flow proceeds to S25.

In S25, the main CPU 32 adds [1] to the variable N that is stored in the RAM 33. Further, the main CPU 32 transmits a control signal to the display portion driving circuit 67, thereby displaying the point display portion 201 and the game number display portion 202 on the liquid crystal panel 5B, as shown in FIG. 12. Then, the main CPU 32 executes the main game process of FIG. 17 again.

Meanwhile, the game server 302 executes the processes of S101 to S105 shown in FIG. 18. Accordingly, the processes of S101 to 105 will be described with reference to FIG. 18. Each of programs shown by S101 to S105 in FIG. 18 is stored in the game server 302 and executed by the game server 302.

First, in S101, the game server 302 determines whether the entry information is received from any one of the slot machines 1 that are connected through the network 401. This determination is executed on the basis of a signal that is output from the server communication circuit 303 in response to reception of the entry information. In this case, when it is determined that the entry information is not received (S101: NO), the flow returns to the main program of the game server 302. When it is determined that the entry information is received (S101:YES), on the other hand, the flow proceeds to S102.

In S102, the game server 302 executes a participant determination process. During the participant determination process, the game server 302 stores the slot machines 1 that have transmitted the entry information as participants of the boxing game. Then, the flow proceeds to S103.

In S103, the game server 302 determines whether the number of slot machines 1 that have been stored as participants of the boxing game reaches the predetermined number. The predetermined number is set beforehand, but the predetermined number may be a constant of 2 or more. In this case, when it is determined that the number of slot machines 1 does not reach the predetermined number (S103: NO), the flow returns to the main program of the game server 302. On the other hand, when it is determined that the number of slot machines 1 reaches the predetermined number (S103: YES), the flow proceeds to S104.

In S104, the game server 302 executes a game-start information transmission process. During the game-start information transmission process, the game server 302 transmits game-start information to each of the slot machines 1 that have transmitted entry information. Then, the flow proceeds to S105.

In S105, the game server 302 executes a clocking-T start process. During the clocking-T start process, the game server 302 starts clocking of the time T. Then, the flow returns to the main program of the game server 302.

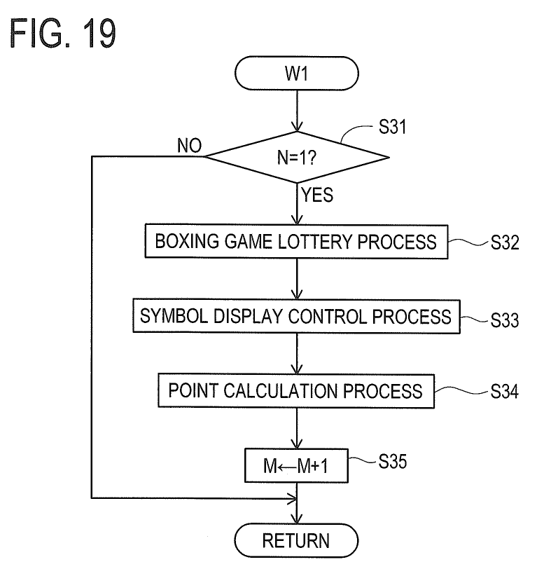

Further, each slot machine 1 executes each of processes of S31 to S35 shown in FIG. 19 at a point of time W1 of the main game process of FIG. 17. Accordingly, the processes of S31 to S35 will be described with reference to FIG. 19. Each of programs shown by S31 to S35 in FIG. 19 is stored in the ROM 34 or the RAM 33 of each slot machine 1, and executed by the main CPU 32.

First, as shown in FIG. 19, in S31, the main CPU 32 determines whether a variable N that is stored in the RAM 33 is [1] or not. In this case, when it is determined that the variable N is not [1] (S31:NO), the flow returns to the main game process of FIG. 17 and proceeds to S15. When it is determined that the variable N is [1] (S31: YES), on the other hand, the flow proceeds to S32.

In S32, the main CPU 32 executes a boxing game lottery process. Specifically, the main CPU 32 selects random numbers respectively corresponding to the video reels V1, V2, and V3 from a numerical value range of [0] to [255]. In addition, the main CPU 32 determines code numbers of the video reels V1, V2, and V3 on the basis of the three selected random numbers. The main CPU 32 stores the determined code numbers of the video reels V1, V2, and V3 in the RAM 33 and then proceeds to S33.

In this case, since the code numbers of the video reels V1, V2, and V3 correspond to the symbol numbers (symbol numbers of FIG. 10) that are rearranged on the pay line L in the liquid crystal panel 5B, the main CPU 32 determines the code numbers of the video reels V1, V2, and V3. By this determination, symbols displayed on the display windows W1, W2, and W3 when the unit game of the slot game is finished are determined. For example, in the case where the main CPU 32 determines the code numbers of the video reels V1, V2, and V3 and thus the symbol numbers of the video reels V1, V2, and V3 are determined as [04], [09], and [06], the main CPU 32 allows the symbols [ATTACK] and [DAMAGE] to be displayed as shown in FIG. 12 on the display windows W1, W2, and W3 when the unit game of the slot game is finished (refer to FIG. 10). By determining the code numbers of the video reels V1, V2, and V3 in this manner, a lottery of display symbols related to the boxing game is executed.

Then, when the flow proceeds to S33, the main CPU 32 executes a symbol display control process. Specifically, the main CPU 32 first executes a reel rotation process. In other words, the main CPU 32 transmits a control signal to the sub control board 72, thereby causing a start of rotation display of the video reels V1, V2, and V3 in the display windows W1, W2, and W3 of the liquid crystal panel 5B. At this time, the main CPU 32 instructs the sub control board 72 to transparentize the reel bands of the video reels V1, V2, and V3, except for the symbols [ATTACK] and [DAMAGE] drawn on the reel bands.

In addition, when current timing becomes predetermined stop timing at which rotation of each of the video reels V1, V2, and V3 is stopped, the main CPU 32 executes a reel stop process, and transmits a control signal to the sub control board 72 to stop the video reels V1, V2, and V3 in a rotating state on the basis of the code numbers stored in the RAM 33. As a result, the display symbols determined in S32 are displayed on the display windows W1, W2, and W3 of the liquid crystal panel 5B.

In addition, when the flow proceeds to S34, the main CPU 32 executes a point calculation process. During the point calculation process, with respect to the symbols [ATTACK] and [DAMAGE] displayed on the display windows W1, W2, and W3 of the liquid crystal panel 5B, the main CPU 32 calculates the point amount on the basis of the table that is shown in FIG. 11. During the point calculation, with respect to the symbol [ATTACK], a point of [+3] is counted whenever the corresponding symbol is displayed. Meanwhile, with respect to the symbol [DAMAGE], a point of [−1] is counted whenever the corresponding symbol is displayed. The point amount counted by the above method is added to the point amount stored in the RAM 33 as the point information, and a value obtained by adding the counted point amount to the stored point amount is overwritten in the RAM 33 as the point information. Then, the main CPU 32 transmits a control signal to the display portion driving circuit 67, thereby displaying the point information (addition value calculated in S34), which is stored in the RAM 33, on the point display portion 201 of the liquid crystal panel 5B. Then, the flow proceeds to S35.

In S35, the main CPU 32 adds [1] to the variable M that is stored in the RAM 33. Then, the main CPU 32 transmits a control signal to the display portion driving circuit 67, thereby displaying a value of the variable M, which is stored in the RAM 33, on the game number display portion 202 of the liquid crystal panel 5B. Then, the flow returns to the main game process of FIG. 17 and proceeds to S15.

Further, each slot machine 1 executes each of processes of S41 to S45 shown in FIG. 20 at a point of time W2 of the main game process of FIG. 17. Accordingly, the processes of S41 to S45 will be described with reference to FIG. 20. Each of the programs shown in S41 to S45 in FIG. 20 is stored in the ROM 34 or the RAM 33 of each slot machine 1, and executed by the main CPU 32.

First, as shown in FIG. 20, in S41, the main CPU 32 determines whether a variable M stored in the RAM 33 is [M1] or not. At this time, the [M1] may be set beforehand, but may be, for example, [20]. In this case, when it is determined that the variable M is not [M1] (S41: NO), the main CPU 32 executes the main game process of FIG. 17 again. When it is determined that the variable M is [M1] (S41: YES), on the other hand, the flow proceeds to S42.

In S42, the main CPU 32 executes a game-related information transmission process. During the game-related information transmission process, the main CPU 32 transmits game-related information including data, which informs the point amount stored in the RAM 33 as the point information and the credit amount stored in the RAM 33 as the credit information, to the game server 302. Then, the flow proceeds to S43.

In S43, the main CPU 32 determines whether game-win/lose information is received from the game server 302. This determination is executed on the basis of a signal that is input from the game communication circuit 104 to the main CPU 32 when the game-win/lose information is received from the game server 302. In this case, when it is determined that the game-win/lose information is not received (S43: NO), the main CPU 32 executes the main game process of FIG. 17 again. When it is determined that the game-win/lose information is received (S43: YES), on the other hand, the flow proceeds to S44.

In S44, the main CPU 32 executes a boxing game result process. During the boxing game result process, the main CPU 32 transmits a control signal to the sub control board 72 on the basis of the game-win/lose information that is received from the game server 302, thereby displaying the effect screen such as shown in FIG. 14 or the effect screen shown in FIG. 15 on the liquid crystal panel 5B.

In other words, when the game-win/lose information that has been received from the game server 302 includes data informing that almost the entire credit amount confiscated from the slot machines 1 determined as the losers is given to the slot machine 1 that is determined as the winner and data informing the credit amount to be given, the main CPU 32 transmits a control signal to the sub control board 72, thereby displaying the effect screen such as shown in FIG. 14 on the liquid crystal panel 5B.

The main CPU 32 adds the credit amount, which is included in the game-win/lose information received from the game server 302, to the credit amount stored in the RAM 33 as the credit information, and overwrites a value, which is obtained by adding the credit amount to the stored credit amount, in the RAM 33 as the credit information. Then, the main CPU 32 transmits a control signal to the display portion driving circuit 67, thereby displaying the credit information (calculated addition value), which is stored in the RAM 33, on the credit amount display portion 9 of the liquid crystal panel 5B.

Meanwhile, when the game-win/lose information that has been received from the game server 302 includes data informing that the credit amount is to be confiscated, the main CPU 32 transmits a control signal to the sub control board 72, thereby displaying the effect screen such as shown in FIG. 15 on the liquid crystal panel 5B.

The main CPU 32 overwrites a numerical value [0] in the credit information that is stored in the RAM 33. Then, the main CPU 32 transmits a control signal to the display portion driving circuit 67, thereby displaying the credit information ([0]), which is stored in the RAM 33, on the credit amount display portion 9 of the liquid crystal panel 5B.

When the flow proceeds to S45, the main CPU 32 executes a variable initialization process. During the variable initialization process, the main CPU 32 substitutes [0] for each variable. Then, the main CPU 32 executes the main game process of FIG. 17 again.

Meanwhile, the game server 302 executes each of processes of S111 to S115 shown in FIG. 20. Accordingly, the processes of S111 to 115 will be described with reference to FIG. 20. Each of the programs shown in S111 to S115 in FIG. 20 is stored in the game server 302 and executed by the game server 302.

First, in S111, the game server 302 determines whether game-related information is received from any one of the slot machines 1 that have transmitted entry information. This determination is executed on the basis of a signal or the like that is output from the server communication circuit 303 in response to reception of the game-related information. In this case, when it is determined that the game-related information is not received (S111:NO), the flow proceeds to S115. On the other hand, when it is determined that the game-related information is received (S111: YES), the flow proceeds to S112.

In S112, the game server 302 determines whether the game-related information is received from all of the slot machines 1 that have transmitted entry information. In this case, when it is determined that the game-related information is received from all of the slot machines 1 that have transmitted the entry information (S112: YES), the flow proceeds to S113 as described below. On the other hand, when it is determined that the game-related information is not received from all of the slot machines 1 that have transmitted the entry information (S112:NO), the flow proceeds to S115.

In S115, the game server 302 determines whether a predetermined time has elapsed. This determination is executed on the basis of the time T when clocking starts in S105. In this case, when it is determined that the predetermined time has not elapsed (S115:NO), the flow returns to the main program of the game server 302. When it is determined that the predetermined time has elapsed (S115: YES), on the other hand, the flow proceeds to S113.

In S113, the game server 302 executes a boxing-game-win/lose process. During the boxing-game-win/lose process, the game server 302 compares the point amounts that are in the game-related information received from the individual slot machines 1 to thereby determine win/lose of a boxing game. At this time, the game server 302 handles the point amount as [0] with respect to the slot machines 1 that have transmitted entry information but not transmitted game-related information within a predetermined time period. In addition, the game server 302 determines the slot machine 1 that has the largest point amount as a winner of the boxing game and the other slot machines 1 as losers of the boxing game.

Further, the flow proceeds to S114 and the game server 302 executes a game-win/lose information transmission process. During the game-win/lose information transmission process, the game server 302 determines to confiscate the credit amount of the slot machines 1 that have become the losers of the boxing game, and transmits game-win/lose information that includes data informing the determined items to the slot machines 1 that have become the losers of the boxing game.

Meanwhile, the game server 302 determines that the credit amount confiscated from the slot machines 1 determined as the losers is given to the slot machine 1 determined as the winner, and transmits game-win/lose information that includes data informing the determined items and the credit amount to be given to the slot machine 1 that has become the winner of the boxing game. From the credit amount, the credit amount of several percents that are to be paid to a game arcade such as a casino is excluded. Then, the flow returns to the main program of the game server 302.

When there are a plurality of slot machines 1 that have the largest point amount, the game server 302 randomly determines one slot machine 1 that will become a winner of the boxing game among the plurality of slot machines 1. In this case, however, the game server 302 may determine that the boxing game ends in a draw, and temporarily keep the credit amount, which is owned by the players of the slot machines 1 that take part in the boxing game, for a next boxing game.

[10. Conclusion]

As described in detail above, in the gaming system 301 according to this embodiment, when a player presses the entry button that is one of the operation buttons 11 in each slot machine 1 (S21: YES), the player can take part in a boxing game on which the entire credit amount that is owned by the corresponding player is bet (S23, S102). The boxing game is executed between the slot machines 1 that are determined by the game server 302 as participants of the boxing game. Each of the slot machines 1 calculates the point amount on the basis of the number of each of the symbols [ATTACK] and [DAMAGE] that are displayed on each of the display windows W1, W2, and W3 until the unit game of the slot game is repeated [M1] times after the entry button is pressed (S41: NO, S34). Meanwhile, the game server 302 determines the slot machine 1 of the winner and the slot machines 1 of the losers according to values of the calculated point amounts (S113). In each of the slot machines 1 that have become the losers, the entire credit amount that is owned by a corresponding player is confiscated at a point of time when the unit game of the slot game is repeated [M1] times after the entry button is pressed, and almost the entire confiscated credit amount is given to the slot machine 1 determined as the winner (S114, S44).

[11. Others]

The present invention is not limited to the above-described embodiments, and various changes and modifications can be made without departing from the sprit and scope of the invention.

For example, when the unit game of the slot game, which is executed immediately after the entry button is pressed, is finished, the point amount may be calculated on the basis of the number of each of the symbols [ATTACK] and [DAMAGE] that are displayed on each of the display windows W1, W2, and W3, and the calculated point amounts may be compared, thereby determining a winner and losers of the boxing game.

Further, during a period until the unit game of the slot game is repeated [M1] times after the entry button is pressed, an aggregated sum of the credit amount that is awarded according to the three symbols rearranged on the pay line L in the liquid crystal panel 5B at each unit game may be calculated, and the calculated aggregated sums may be compared, thereby determining a winner and losers of the boxing game. Alternatively, at the unit games of the slot game that is executed immediately after the entry button is pressed, the credit amounts that are awarded according to the three symbols rearranged on the pay line L in the liquid crystal panel 5B may be compared, and thereby a winner and losers of the boxing game may be determined according to the compared result.

The boxing game may be executed as a one-to-one match. Each match of the boxing game may be executed by a knockout method, such as a tournament, and almost the entire credit amount that is bet on each match of the boxing game may be given to only the slot machine I that has made it to the final of the tournament.

The game server 302 randomly gives a new additional payout to the slot machine 1 that has become a winner of the boxing game.

The game server 302 may be substituted by any one of the slot machines 1 that are connected to the network 401.

[12. Outline of Mah-Jong Game]

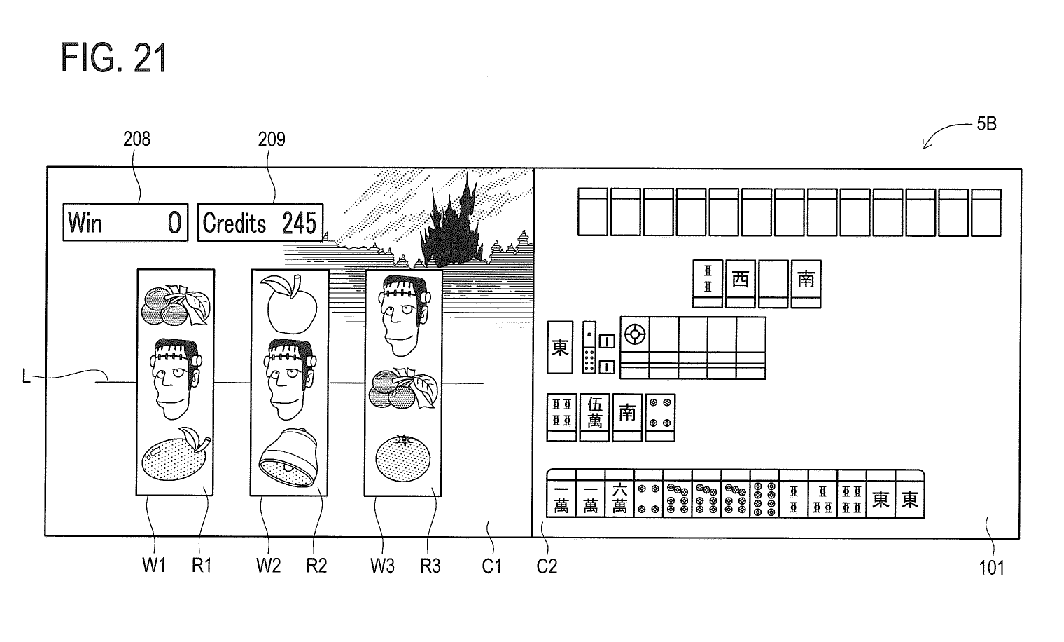

Further, instead of the boxing game, the mah-jong game may be executed as a grab game. FIG. 21 shows a state where a mah-jong game is executed in the liquid crystal panel 5B. As shown in FIG. 21, in the liquid crystal panel 5B when a mah-jong game is executed, a screen C1 where a slot game is executed and a screen C2 where a mah-jong game is executed are divisionally displayed. In the screen C1 where a slot game is executed, the screen of the slot game such as shown in FIG. 8 is displayed. Meanwhile, in the screen C2 where a mah-jong game is executed, a screen that is related to the mah-jong game is displayed, and a game operation of the mah-jong game is executed by touch operations on the touch panel 101.

In addition, in order to execute a mah-jong game instead of a boxing game as the grab game, first, in S103 of FIG. 18, each slot machine 1 sets the number (for example, two or four) of participants that can take part in the mah-jong game as the predetermined number and determines whether the number of participants agrees with the predetermined number. In this case, when it is determined that the number of participants does not agree with the predetermined number (S103:NO), the flow returns to the main program of the game server 302. On the other hand, when it is determined that the number of participants agrees with the predetermined number (S103:YES), the flow proceeds to S104.

When the number of participants does not reach the predetermined number even after the predetermined time has elapsed (S103: NO), the game server 302 itself takes part in the mah-jong game until the number of participants agrees with the predetermined number. Then, when the number of participants agrees with the predetermined number (S103:YES), the flow proceeds to S104.

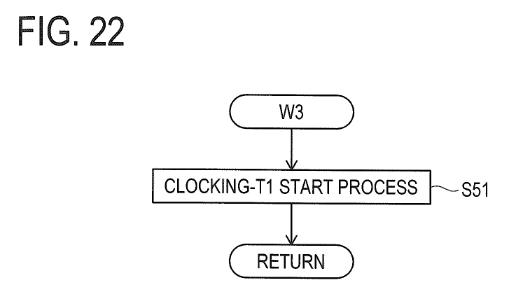

Further, each slot machine 1 executes a process of S51 shown in FIG. 22 at a point of time W3 of the main game process of FIG. 17. Accordingly, the process of S51 will be described with reference to FIG. 22. The program shown in S51 in FIG. 22 is stored in the ROM 34 or the RAM 33 of each slot machine 1, and executed by the main CPU 32.

In other words, if the main CPU 32 executes the main game process of FIG. 17, the flow proceeds to S51 of FIG. 22, and the main CPU 32 executes a clocking-T1 start process. During the clocking-T1 start process, the main CPU 32 starts clocking of the time T1 using the first timer 102. Then, the main CPU 32 returns to the main game process of FIG. 17.

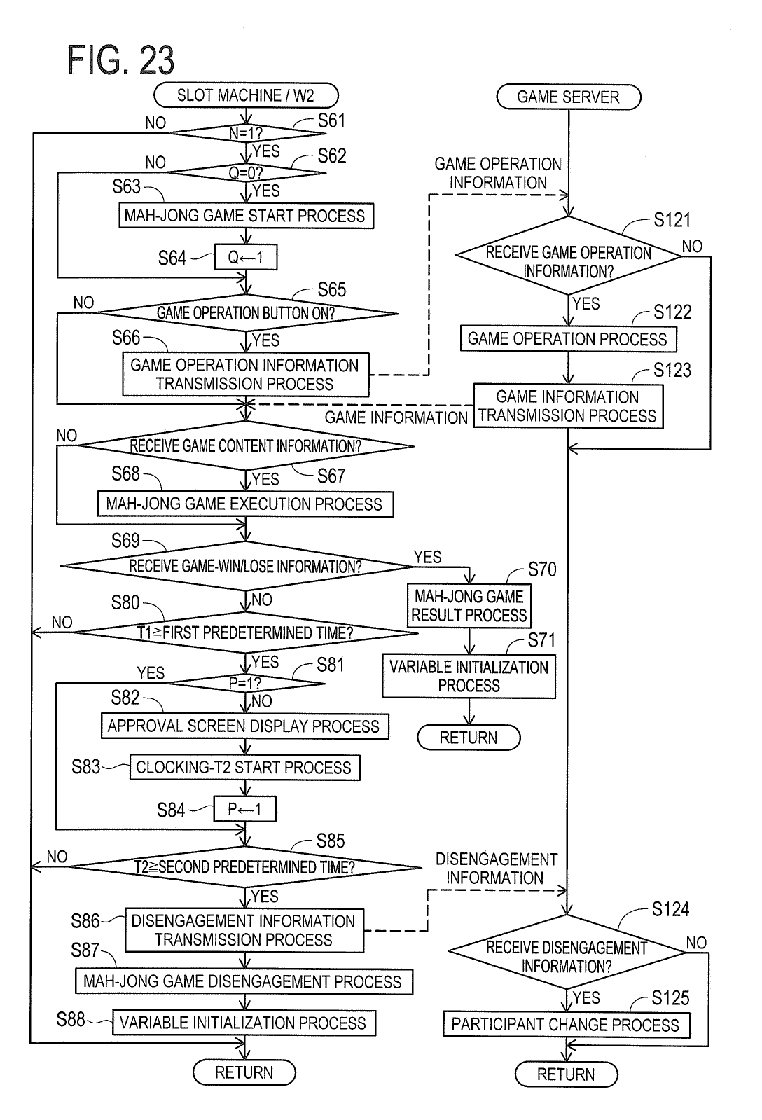

Furthermore, in order to execute a mah-jong game instead of a boxing game as a grab game, at a point of time W2 of the main game process of FIG. 17, each slot machine 1 executes processes of S61 to S88 shown in FIG. 23, instead of processes of S41 to S45 shown in FIG. 20. Accordingly, the processes of S61 to S88 will be described with reference to FIG. 23. Each of the programs shown in S61 to S88 in FIG. 23 is stored in the ROM 34 or the RAM 33 of each slot machine 1, and executed by the main CPU 32.

First, in S61, the main CPU 32 determines whether a variable N that is stored in the RAM 33 is [1]. In this case, when it is determined that the variable N is not [1] (S61:NO), the flow returns to the main game process of FIG. 17. When it is determined that the variable N is [1] (S61:YES), on the other hand, the flow proceeds to S62.

In S62, the main CPU 32 determines whether a variable Q that is stored in the RAM 33 is [0]. In this case, when it is determined that the variable Q is not [0] (S62: NO), the flow proceeds to S65. When it is determined that the variable Q is [0] (S62: YES), on the other hand, the flow proceeds to S63.

In S63, the main CPU 32 executes a mah-jong game start process. During the mah-jong game start process, the main CPU 32 transmits a control signal to the sub control board 72, and divisionally displays the screen C1 where the slot game is executed and the screen C2 where the mah-jong game is executed on the liquid crystal panel 5B, as shown in FIG. 21. Then, the flow proceeds to S64.

In S64, the main CPU 32 substitutes [1] for the variable Q that is stored in the RAM 33. Then, the flow proceeds to S65.

In S65, the main CPU 32 determines whether a player has touched a game operation button that is related to the mah-jong game. This determination is executed on the basis of a signal or the like that is input from the touch panel 101 to the main CPU 32 in response to player's touching of the touch panel 101 on the screen C2 of the liquid crystal panel 5B. In this case, when it is determined that the player does not touch the game operation button (S65:NO), the main CPU 32 proceeds to S67. On the other hand, when it is determined that the player touches the game operation button (S65:YES), the flow proceeds to S66.

In S66, the main CPU 32 executes a game operation information transmission process. During the game operation information transmission process, first, the main CPU 32 specifies operation contents related to the mah-jong game made by the player of the corresponding slot machine 1 on the basis of a signal that is input from the touch panel 101 to the main CPU 32 in response to player's touching of the touch panel 101 on the screen C2 of the liquid crystal panel 5B. Then, the main CPU 32 transmits game operation information including data that informs the operation contents related to the mah-jong game made by the player of the corresponding slot machine 1 to the game server 302 through the game communication circuit 104. However, when it is determined that current timing is not timing at which the player of the slot machine 1 executes an operation on the mah-jong game in view of an execution situation of the mah-jong game that is grasped on the basis of the game information received from the game server 302, the main CPU 32 ignores this S66. Then, the flow proceeds to S67.

In S67, the main CPU 32 determines whether game content information is received from the game server 302. This determination is executed on the basis of a signal that is input from the game communication circuit 104 to the main CPU 32 in response to reception of the game content information from the game server 302. In this case, when it is determined that the game content information is not received from the game server 302 (S67:NO), the flow proceeds to S69 as described below. On the other hand, when it is determined that the game content information is received from the game server 302 (S67:YES), the flow proceeds to S68.

In S68, the main CPU 32 executes a mah-jong game execution process. During the mah-jong game execution process, the main CPU 32 transmits a control signal to the sub control board 72 on the basis of the game content information received from the game server 302, thereby executing change display on the screen C2 of the liquid crystal panel 5B. Then, the flow proceeds to S69.

In S69, the main CPU 32 determines whether game-win/lose information has been received from the game server 302. This determination is executed on the basis of a signal that is input from the game communication circuit 104 to the main CPU 32 in response to reception of the game-win/lose information from the game server 302. In this case, when it is determined that the game-win/lose information has been received from the game server 302 (S69: YES), the flow proceeds to S70.

In S70, the main CPU 32 executes a mah-jong game result process. During the mah-jong game result process, first, the main CPU 32 transmits a control signal to the sub control board 72 on the basis of the game-win/lose information received from the game server 302, thereby executing change display on the screen C2 of the liquid crystal panel 5B.

Further, the main CPU 32 transmits a control signal to the sub control board 72 on the basis of the game-win/lose information received from the game server 302, thereby displaying the effect screen such as shown in FIG. 14 or the effect screen shown in FIG. 15 on the liquid crystal panel 5B.

In other words, when the game-win/lose information that has been received from the game server 302 includes data informing that almost the entire credit amount confiscated from the slot machines 1 determined as the losers is to be given to the slot machine 1 determined as the winner and data informing the credit amount to be given, the main CPU 32 transmits a control signal to the sub control board 72, thereby displaying the effect screen such as shown in FIG. 14 on the liquid crystal panel 5B.

The main CPU 32 adds the credit amount, which is included in the game-win/lose information received from the game server 302, to the credit amount that is stored in the RAM 33 as the credit information, and overwrites a value, which is obtained by adding the credit amount to the stored credit amount, in the RAM 33 as the credit information. Then, the main CPU 32 transmits a control signal to the display portion driving circuit 67, thereby displaying the credit information (calculated addition value) that is stored in the RAM 33 on the credit amount display portion 9 of the liquid crystal panel 5B.

Meanwhile, when the game-win/lose information that has been received from the game server 302 includes data informing that the credit amount is to be confiscated, the main CPU 32 transmits a control signal to the sub control board 72, thereby displaying the effect screen such as shown in FIG. 15 on the liquid crystal panel 5B.

Further, the main CPU 32 overwrites a numerical value [0] in the credit information of the RAM 33. Then, the main CPU 32 transmits a control signal to the display portion driving circuit 67, thereby displaying the credit information ([0]) that is stored in the RAM 33 on the credit amount display portion 9 of the liquid crystal panel 5B.

When the flow proceeds to S71, the main CPU 32 executes a variable initialization process. During the variable initialization process, the main CPU 32 substitutes [0] for each variable. Then, the main CPU 32 returns to the main game process of FIG. 17.

Meanwhile, in above S69, when it is determined that the game-win/lose information is not received from the game server 302 (S69:NO), the main CPU 32 proceeds to S80 and determines whether a first predetermined time has elapsed. This determination is executed on the basis of the time T1 at which clocking started in S51. In this case, when it is determined that the first predetermined time has not elapsed (S80: NO), the flow returns to the main game process of FIG. 17. On the other hand, when it is determined that the first predetermined time has elapsed (S80: YES), the flow proceeds to S81.

In S81, the main CPU 32 determines whether a variable P that is stored in the RAM 33 is [1]. In this case, when it is determined that the variable P is [1] (S81: YES), the flow proceeds to S85. Meanwhile, when it is determined that the variable P is not [1] (NO in S81), the flow proceeds to S82.

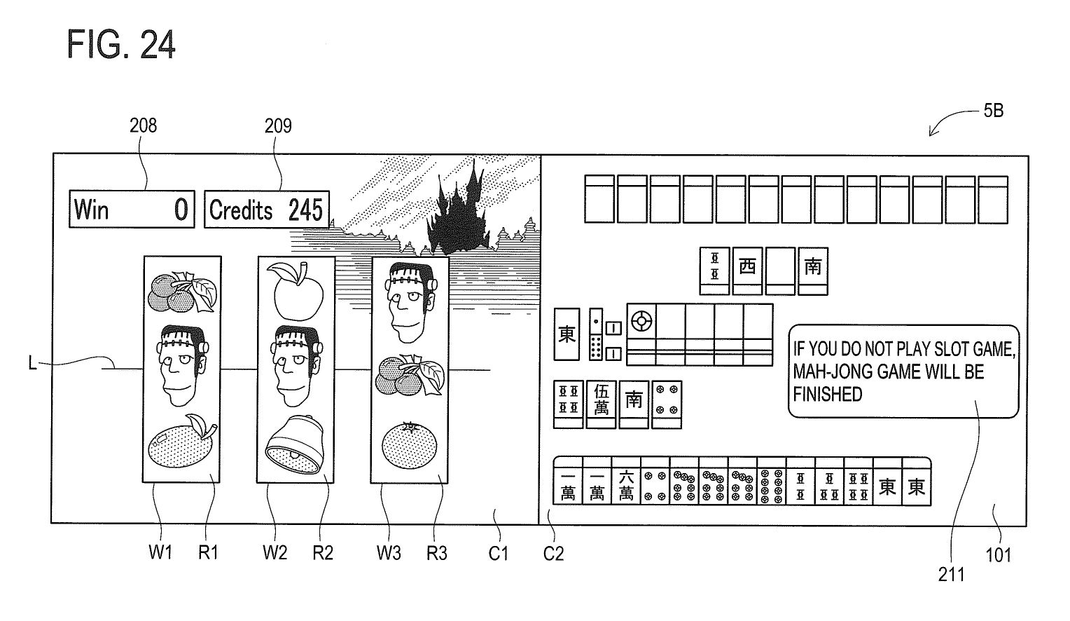

In S82, the main CPU 32 executes an approval screen display process. During the approval screen display process, the main CPU 32 transmits a control signal to the sub control board 72, thereby additionally displaying an approval screen 211 where a message [IF YOU DO NOT PLAY A SLOT GAME, A MAH-JONG GAME IS FINISHED] is described on the screen C2 of the liquid crystal panel 5B, as shown in FIG. 24. Then, the flow proceeds to S83.

In S83, the main CPU 32 executes a clocking-T2 start process. During the clocking-T2 start process, the main CPU 32 starts clocking of the time T2 using the second timer 103. Then, the flow proceeds to S84.

In S84, the main CPU 32 substitutes [1] for the variable P that is stored in the RAM 33. Then, the flow proceeds to S85.

In S85, the main CPU 32 determines whether a second predetermined time has elapsed. This determination is executed on the basis of the time T2 at which clocking starts in above S83. In this case, when it is determined that the second predetermined time has not elapsed (S85: NO), the flow returns to the main game process of FIG. 17. When it is determined that the second predetermined time has elapsed (S85: YES), on the other hand, the flow proceeds to S86.

In S86, the main CPU 32 executes a disengagement information transmission process. During the disengagement information transmission process, the main CPU 32 transmits disengagement information, which includes data informing that the corresponding slot machine 1 is compulsorily disengaged from the mah-jong game, to the game server 302 through the game communication circuit 104. Then, the flow proceeds to S87.

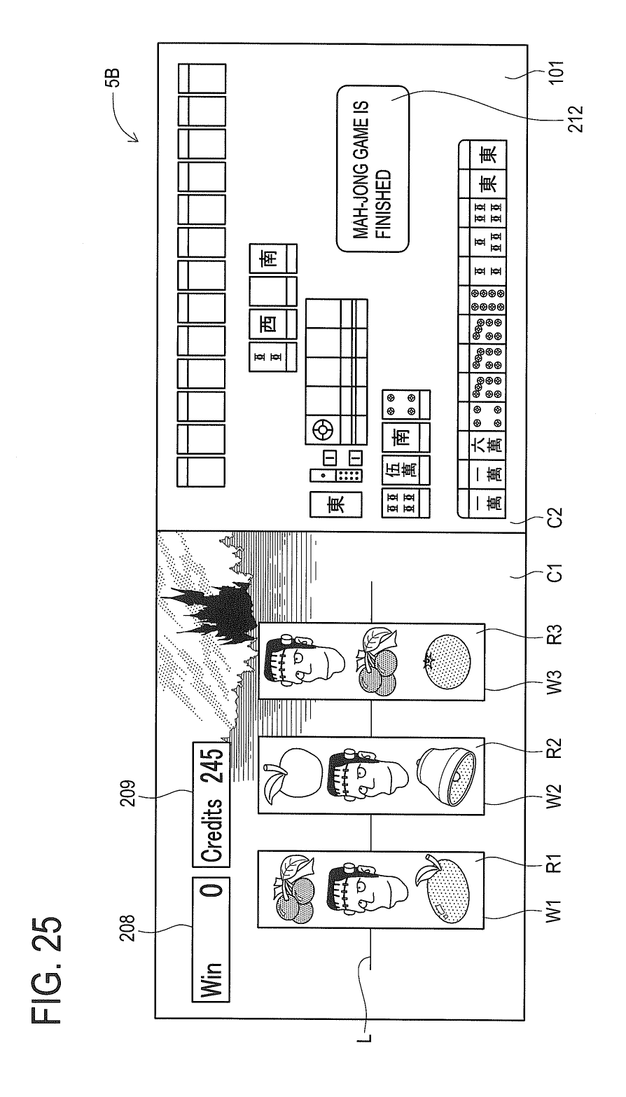

In S87, the main CPU 32 executes a mah-jong game disengagement process. During the mah-jong game disengagement process, the main CPU 32 transmits a control signal to the sub control board 72, thereby additionally displaying a disengagement screen 212 where a message [A MAH-JONG GAME IS FINISHED] is described on the screen C2 of the liquid crystal panel 5B, as shown in FIG. 25. Then, if the predetermined time has elapsed, the main CPU 32 transmits a control signal to the sub control board 72, thereby finishing the division display such as shown in FIG. 21 in the liquid crystal panel 5B and displaying the screen of the slot game shown in FIG. 8 on the liquid crystal panel 5B. Then, the flow proceeds to S88.

In S88, the main CPU 32 executes a variable initialization process. During the variable initialization process, the main CPU 32 substitutes [0] for each variable. Then, the flow returns to the main game process of FIG. 17.

The processes of S61 to S88 that are shown in FIG. 23 may be processed in parallel by a main CPU that is newly provided to each slot machine 1.

Meanwhile, the game server 302 executes each of processes of S121 to S125 shown in FIG. 23. Accordingly, the processes of S121 to S125 will be described with reference to FIG. 23. Each of the programs shown by S121 to S125 in FIG. 23 is stored in the game server 302 and executed by the game server 302.

First, in S121, the game server 302 determines whether game operation information has been received from any one of the slot machines 1 that have transmitted entry information. This determination is executed on the basis of a signal that is output from a server communication circuit 303 in response to reception of the game operation information. In this case, when it is determined that the game operation information is not received (S121: NO), the flow proceeds to S124. On the other hand, when it is determined that the game operation information has been received (S121: YES), the flow proceeds to S122.

In S122, the game server 302 executes a game operation process. During the game operation process, the game server 302 develops the mah-jong game on the basis of the game operation information that is received from the slot machine 1. Then, the flow proceeds to S123.

In S123, the game server 302 executes a game information transmission process. During the game information transmission process, the game server 302 transmits game information, which includes data that informs the development of the mah-jong game in above S122, to each of the slot machines 1 that have transmitted entry information.

At this time, when the development of the mah-jong game in above S122 corresponds to the middle of the game, the game server 302 transmits game content information as game information, which includes data informing the progress of the mah-jong game in above S122, to each of the slot machines 1 that have transmitted entry information.

When the development of the mah-jong game in above S122 corresponds to the end of the game, the game server 302 determines the slot machine 1 that has acquired the highest score at the mah-jong game as a winner of the mah-jong game, and the other slot machines 1 as losers of the mah-jong game. Further, the game server 302 determines to confiscate the credit amount of the slot machines 1 that have become the losers, and transmits game-win/lose information as game information, which includes data informing the determined items, to the slot machines 1 that have become the losers of the mah-jong game.

Meanwhile, the game server 302 determines that almost the entire credit amount confiscated from the slot machines 1 determined as the losers is given to the slot machine 1 that has become the winner, and transmits game-win/lose information as game information, which includes data informing the determined items and the credit amount to be given, to the slot machine 1 that has become the winner of the mah-jong game. From the credit amount confiscated from the slot machines 1 that have become the losers, the credit amount of several percents that are paid to a game arcade such as a casino is excluded. Then, the flow proceeds to S124.

When there are a plurality of slot machines 1 that have acquired the highest score, the game server 302 randomly determines one slot machine 1 that will become a winner of the mah-jong game among the plurality of slot machines 1. However, the game server 302 may determine that the mah-jong game ends in a draw, and temporarily keep the credit amount, which is owned by the players of the slot machines 1 that take part in the mah-jong game, for a next mah-jong game.

In S124, the game server 302 determines whether disengagement information has been received from any one of the slot machines 1 that have transmitted entry information. This determination is executed on the basis of a signal that is output from the server communication circuit 303 in response to reception of the disengagement information. In this case, when it is determined that the disengagement information is not received (S124: NO), the flow returns to the main program of the game server 302. On the other hand, when it is determined that the disengagement information has been received (S124: YES), the flow proceeds to S125.

In S125, the game server 302 executes a participant change process. During the participant change process, the game server 302 itself executes a game operation of the mah-jong game in place of the slot machines 1 that have transmitted the disengagement information. Then, the flow returns to the main program of the game server 302.

Even though the gaming system 301 executes the mah-jong game, a player of each slot machine 1 may play the grab game on which the player bets the entire credit amount owned by the player in parallel with the slot game.

However, the present invention is not limited to the mah-jong game, and may be applied to a side game that can be executed in parallel with the slot game. For example, a card game such as a poker or a blackjack and a video roulette may be executed, instead of the mah-jong game.

What is claimed is:

1. A gaming system comprising:
game clients that are composed of a plurality of slot machines, respectively; and
a game server that manages the individual game clients,
wherein the each game client is programmed to execute the following processes (a) to (c) of:
(a) simultaneously executing a slot game and a grab game on which the total credit amount that is awarded at the slot game is bet;
(b) transmitting game-related information related to the grab game to the game server; and
(c) calculating the total credit amount on the basis of game-win/lose information when the following game-win/lose information has been received from the game server, and
the game server is programmed to execute the following processes (α) to (γ) of:
(α) determining a winner and losers of the grab game for each of the game clients on the basis of the game-related information when the game-related information has been received;
(β) transmitting, to the game clients determined as the losers of the grab game by the process (α), game-win/lose information indicating that the total credit amount of the game clients is to be confiscated; and
(γ) transmitting, to the game client determined as the winner of the grab game by the process (α), game-win/lose information indicating that the distributable credit amount among the total credit amount of the game clients determined as the losers of the grab game by the process (α) is to be given.

2. The gaming system according to claim 1,
wherein the each game client includes an input device and is programmed to execute, before executing the processes (a) to (c), the following processes (1) and (2) of:
(1) transmitting entry information indicating that the game clients take part in the grab game to the game server, when players use the input devices to input data indicating that the game clients take part in the grab game; and
(2) allowing execution of the processes (a) to (c) only when the following game-start information is received from the game server, and
the game server is programmed to execute, before executing the processes (α) to (γ), the following processes (I) and (II) of:
(I) determining the game clients that have transmitted the entry information as participants of the grab game when the entry information has been received; and
(II) transmitting game-start information indicating that the grab game starts to the game clients determined as the participants by the (I) when the number of game clients determined as the participants has reached a predetermined number.

3. The gaming system according to claim 1,
wherein the each game client is programmed to execute, when executing the processes (a) and (b), the following processes (a-1) and (b-1) of:
(a-1) showing symbols for the grab game to players in synchronization with a unit game of the slot game; and
(b-1) including in the game-related information one of a score corresponding to the symbols for the grab game or a total value calculated by taking the score corresponding to the symbols for the grab game by a predetermined number of times of the unit game of the slot game, and
the each game client is programmed to execute, when executing the process (α), the following process (α-1) of:
(α-1) competing for one of the score or the total value included in the game-related information.

4. The gaming system according to claim 1,
wherein the each game client is programmed to execute, when executing the process (b), the following process (b-2) of:
(b-2) including in the game-related information one of a payout that corresponds to a combination of the symbols shown to each player at a unit game of the slot game or a total value obtained by taking the payout that corresponds to the combination of the symbols shown to each player at the unit game of the slot game by a predetermined number of times of the unit game of the slot game, and
the each game client is programmed to execute, when executing the process (α), the following process (α-2) of:
(α-2) competing for one of the payout or the total value included in the game-related information.

5. A gaming system comprising:
game clients that are composed of a plurality of slot machines, respectively; and
a game server that manages the individual game clients,
wherein the each game client includes an input device and a display and is programmed to execute the following processes (a) to (f) of:
(a) transmitting entry information, which indicates that the game clients take part in a grab game on which the total credit amount that is awarded at the slot game is bet, to the game server when players use the input devices to input data indicating that the game clients take part in the grab game;
(b) executing the grab game on the displays in asynchronous with a unit game of the slot game on the basis of game-start information or game content information when the following game-start information or the following game content information has been received from the game server;
(c) transmitting game operation information related to operation data of the grab game to the game server when the players use the input devices to input the operation data of the grab game while the grab game is executed on the displays;
(d) displaying an approval screen requesting an acceptance of disengagement from the grab game on the display when a first predetermined time has elapsed after the unit game of the slot game is executed but a next unit game is not executed yet;
(e) transmitting disengagement information, which indicates that the game clients are disengaged from the grab game, to the game server when a second predetermined time has elapsed after the approval screen is displayed on the display but the next unit game is not executed yet; and
(f) calculating the total credit amount on the basis of game-win/lose information when the following game-win/lose information has been received from the game server, and
the game server is programmed to execute the following processes (α) to (δ) of:
(α) when the entry information has been received, determining the game clients that have transmitted the entry information as participants of the grab game;
(β) when a number of game clients determined as the participants has reached a predetermined number, transmitting game-start information indicating that the grab game starts to the game clients determined as the participants by the process (α);
(γ) when the disengagement information has been received, changing the game client as the participant of the grab game that has transmitted the disengagement information to the game server that has a predetermined credit amount;
(δ) when the game operation information has been received, determining a situation of the grab game or a winner and losers of the grab game for each game client that has transmitted the game-start information in the process (β) on the basis of the game operation information;
(ε) when the situation of the grab game is determined in the process (δ), transmitting game content information related to the situation of the grab game determined in the process (δ) to the game clients that have transmitted the game-start information in the process (β); and
(ζ) when the winner and losers of the grab game is determined in the process (δ), transmitting game-win/lose information indicating that the total credit amount of the game clients is to be confiscated to the game clients determined as the losers of the grab game by the process (δ), while transmitting game-win/lose information indicating that the distributable credit amount among the total credit amount of the game clients determined as the losers of the grab game is to be given to the game client determined as the winner of the grab game by the process (δ).
